(19) United States
(12) Patent Application Publication
(10) Pub. No.: US 2023/0030554 A1
(43) Pub. Date: Feb. 2, 2023

(54) METHODS AND APPARATUS FOR SEPERATING KERNELS FROM A CORN COB

(71) Applicant: Hagaman Farms, LLC, Berryville, VA (US)

(72) Inventor: Boynton Craig Hagaman, Berryville, VA (US)

(73) Assignee: Hagaman Farms, LLC, Berryville, VA (US)

(21) Appl. No.: 17/444,184

(22) Filed: Jul. 31, 2021

(51) Int. Cl. A01F 11/06; A01F 5/00

(52) U.S. Cl. CPC A01F 11/06; A01F 5/00

(57) ABSTRACT

Some embodiments are directed to methods and apparatus for separating corn kernels from a cob of an ear of corn, each of the corn kernels defining a base portion that is attached to an exterior of the corn cob. A circular blade defines an axis and a central aperture around the axis that is open at front and rear ends. A holder retains the ear of corn along the axis of the circular blade, and a driver moves the ear of corn along the axis towards the blade, to enable the blade to contact the base of the corn kernels from the corn cob, and thereafter move the cob that has been separated from corn kernels through the blade central aperture. The driver receives manually input force and increases power of the input force to result in increased force applied to the corn cob.

### BACKGROUND

Some embodiments are directed toward methods and apparatus for separating corn kernels from a cob of an ear of corn. However, other embodiments may be directed toward methods and apparatus for processing or otherwise manipulating other objects including but not limited to other vegetables.

Numerous types of vegetables, including corn, can be processed to enhance their preparation and consumption. For example, it may be beneficial to separate corn kernels from a corn cob to enhance or otherwise augment their preparation or consumption by humans, other animals, or for any other use.

In other words, although corn kernels may be consumed directly off of the cob in some instances, external circumstances may necessitate or make beneficial the removal of the kernels prior to consumption or other usages. For example, when corn is to be included as part of a greater recipe, corn is to be served in professional or formal environments, or when corn is to be canned and preserved for future use, it may be advantageous or necessary to remove kernels from their central cobs prior to use or consumption.

### SUMMARY

Although there exist methods for facilitating such removal, such as knives, simple manually actuated devices, and industrial machines, it may be advantageous to provide methods and apparatus for removing corn kernels from central cobs, in a way to reduce excessive manual force and to avoid electric or other artificially powered machines. However, it is important to note that the present disclosure is not limed to removing kernels from a corn cob, and alternative embodiments can be used in many other contexts including but not limited to preparation and/or manipulation of other vegetables.

Some embodiments are thus directed toward methods and apparatus for removing corn kernels from a central corn cob. One such exemplary embodiment is directed toward methods and apparatus wherein an ear of corn is driven toward a circular blade such that kernels may be separated from the cob. The methods and apparatus include a circular blade that defines an axis and a central aperture around the axis that is open and front and rear ends, as well as a holder that is configured to retain the ear of corn along the axis of the circular blade. Furthermore, the apparatus includes a driver that is configured to move the ear of corn along the axis towards the blade, to enable the blade to contact the base of the corn kernels so as to separate the contacted corn kernels from the corn cob, and thereafter move the corn cob that has been separated from the corn kernels through the blade central aperture, the driver being configured to receive manually input force and to increase power of the input force to result in increased force applied to the corn cob.

Some embodiments include a central rod within the driver, wherein the central rod passes through the actuating mechanism and is driven forward to push the corn towards the blade.

Some embodiments include a trigger mechanism within the driver, where the trigger actuates the driver and initiates movement of the central rod.

Some embodiments include frame and trigger components within the trigger mechanism, wherein the frame is a stationary component and the trigger is movable. In such embodiments, the trigger component may be pulled to initiate the engagement of secondary mechanisms to drive the central rod forward.

Some embodiments include at least one trigger pin within the driver such that the trigger pin(s) couple the frame and trigger components. Furthermore, some embodiments include at least one trigger pin within the driver that is independent of the frame component. In such embodiments, the independent trigger pin is configured such that the movement of the trigger initiates movement of the trigger pin.

Some embodiments include a secondary rod cam component within the driver such that the rod cam component is configured to make direct contact with the independent trigger pin. In such embodiments, the movement of the trigger pin initiates movement of the secondary rod cam component. Furthermore, some embodiments include a rod cam component securely coupled to the central rod such that movement of the rod cam component initiates movement of the central rod.

Some embodiments include a compression spring within the driver wherein the compression spring is located directly in front of the rod cam component. In such embodiments, the compression spring is configured such that the movement of the rod cam component initiates the compressing of the compression spring. Furthermore, the compression spring decompresses following release of the trigger, pushing the rod cam component back to its initial position while maintaining the position of the central rod.

Some embodiments include a secondary pusher component within the driver, wherein the secondary pusher component is coupled with the central rod and configured to make direct contact with the base of an ear of corn such that the ear of corn is driven towards the blade.

Some embodiments include automated or electric components within the driver such that the rod is driven forward by automated or electric mechanisms.

Some embodiments include a holder that is configured to hold the blade such that the blade is securely incorporated into the holder.

Some embodiments include a blade that is configured to be removable from the holder or greater apparatus for cleaning. Furthermore, some embodiments include a holder that is configured to be removable from the greater apparatus for cleaning.

Some embodiments include a holder that is configured to be a partially enclosed cylinder such that the holder may contain the ear of corn and allow separated corn kernels to escape through openings in the holder.

Some embodiments include an end cap component within the holder such that the end cap component encloses the holder. In such embodiments, the end cap defines a cavity configured to allow central cobs from ears of corn to pass through the cavity and escape the apparatus following separation. Furthermore, some embodiments include an end cap component configured to hold the blade such that the blade is securely incorporated into the end cap component.

Some embodiments include a reversal mechanism for reversing the motion of the driver. Furthermore, some embodiments include a reversal mechanism such that the reversal mechanism drives the central rod back towards its initial position.

Some embodiments include thumb plate and compression spring components within the reversal mechanism such that the components apply and release pressure upon the central rod to reverse the motion of the central rod.

Some embodiments include a blade that is configured to be tapered in geometry.

Reference was made above towards embodiments directed towards a method and apparatus for separating corn kernels from a central corn cob. However, the above embodiments may be directed towards methods and apparatus for processing or otherwise manipulating other objects, including but not limited to other vegetables.

### BRIEF DESCRIPTIONS OF DRAWINGS

Various exemplary aspects of the systems and methods will be described in detail, with reference to the following figures, wherein:

FIG. 1 is an isometric illustration of a complete corn stripping apparatus, according to various exemplary embodiments;

FIGS. 2A-2B are front and top view illustrations of FIG. 1;

FIG. 3 is a full section view illustration of FIG. 1;

FIG. 4 is an isometric illustration of a corn stripping blade, according to various exemplary embodiments;

FIGS. 5A-5B are front and side view illustrations of FIG. 4;

FIG. 6 is an isometric illustration of cob holder side straps, according to various exemplary embodiments;

FIG. 7 is an isometric illustration of a cob holder containing an end ring, base ring, and side straps, according to various exemplary embodiments;

FIG. 8 is an isometric illustration of a cob holder containing an end ring, base ring, side straps, and threaded portions on end and base rings, according to various exemplary embodiments;

FIG. 9 is an isometric illustration of an end cap, according to various exemplary embodiments;

FIG. 10 is an isometric illustration of a base cap, according to various exemplary embodiments;

FIG. 11 is an isometric illustration of a cob holder containing base and end caps, according to various exemplary embodiments;

FIG. 12 is an isometric exploded illustration of a cob holder showing the construction of the apparatus with end and base rings, side straps, threaded portions, and end and base caps, according to various exemplary embodiments;

FIG. 13 is an isometric illustration of a cob holder supporting a corn stripping blade, according to various exemplary embodiments;

FIG. 14 is an isometric exploded illustration of a cob holder showing the construction of the apparatus with the corn stripping blade, according to various exemplary embodiments;

FIGS. 15A-15B are front and top view illustrations of FIG. 12;

FIG. 16 is an isometric illustration of a straight central rod, according to various exemplary embodiments;

FIG. 17 is an isometric illustration of a comfort grip, according to various exemplary embodiments;

FIG. 18 is an isometric illustration of a pusher cap, according to various exemplary embodiments;

FIG. 19 is an isometric illustration of the portion of the apparatus known as the pusher device, according to various exemplary embodiments;

FIG. 20 is an isometric exploded illustration showing the construction of a pusher device, according to various exemplary embodiments;

FIG. 21 is a front view illustration of FIG. 19.

FIG. 22 is an isometric illustration of an actuating device frame, according to various exemplary embodiments;

FIGS. 23A-23B are top and front view illustrations of FIG. 22;

FIG. 24 is an isometric illustration of an actuating device frame mounted upon a central rod, according to various exemplary embodiments;

FIG. 25 is an isometric illustration of a trigger, according to various exemplary embodiments;

FIG. 26 is an isometric illustration of a trigger fit with trigger pins, according to various exemplary embodiments;

FIG. 27 is an isometric exploded illustration of trigger pins fitting to a trigger, according to various exemplary embodiments;

FIGS. 28A-28B are top and front view illustrations of FIG. 25;

FIG. 29 is an isometric illustration of a trigger fitting into an actuating device frame, according to various exemplary embodiments;

FIG. 30 is an isometric exploded illustration of a trigger fitting into an actuating device frame using trigger pins, according to various exemplary embodiments;

FIG. 31 is an isometric illustration of a trigger pin, according to various exemplary embodiments;

FIG. 32 is an isometric illustration of a rod cam, according to various exemplary embodiments;

FIG. 33 is an isometric illustration of a rod cam and compression spring mounted upon a central rod, according to various exemplary embodiments;

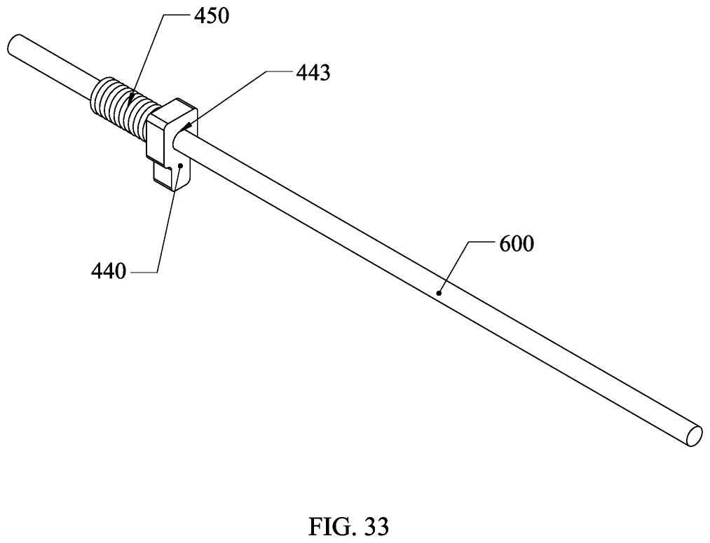

FIG. 34 is an isometric illustration of a rod cam fit to the trigger pins of a trigger, including a compression spring and central rod, according to various exemplary embodiments;

FIG. 35 is an isometric illustration of a spanner nut, according to various exemplary embodiments;

FIG. 36 is a secondary view illustration of FIG. 35;

FIG. 37 is an isometric exploded illustration showing the attachment of a spanner nut to a base cap and actuating device frame, according to various exemplary embodiments;

FIG. 38 is an isometric illustration of a spanner nut mounted upon a central rod, according to various exemplary embodiments;

FIG. 39 is an isometric illustration of an actuating device, according to various exemplary embodiments;

FIG. 40 is an isometric exploded illustration of an actuating device, showing the attachment and coupling of various components, according to various exemplary embodiments;

FIG. 41 is an isometric illustration of an actuating device mounted upon a central rod, according to various exemplary embodiments;

FIG. 42 is an isometric exploded illustration of an actuating device mounted upon a central rod, showing the attachment and coupling of the rod to various other components, according to various exemplary embodiments;

FIGS. 43A-43B are top and front view illustrations of FIG. 39;

FIGS. 44A-44B are top and front view illustrations of FIG. 41;

FIG. 45 is a full section view illustration of FIG. 39;

FIG. 46 is an isometric illustration of a thumb plate reversal mechanism, according to various exemplary embodiments;

FIGS. 47A-47B are top and front view illustrations of a thumb plate reversal mechanism coupling with an actuating device frame, according to various exemplary embodiments;

FIG. 48 is an isometric illustration of a thumb plate reversal mechanism coupled with an actuating device frame and mounted upon a central rod, according to various exemplary embodiments; and

FIG. 49 is a front view illustration of FIG. 48.

### DETAILED DESCRIPTION

These and other features and advantages are described in, or are apparent from, the following detailed description of various exemplary embodiments.

It will be understood that when an element is referred to as being “on”, “connected”, or “coupled” to another element, it can be directly on, connected, or coupled to the other element or intervening elements that may be present. In contrast, when an element is referred to as being “directly on”, “directly connected”, or “directly coupled” to another element, there are no intervening elements present. As used herein the term “and/or” includes any and all combinations of one or more of the associated listing items. Further, it will be understood that when a layer is referred to as being “under” another layer, it can be directly under or one or more intervening layers may also be present. In addition, it will also be understood that when a layer is referred to as being “between” two layers, it can be the only layer between the two layers, or one or more intervening layers may also be present.

It will be understood that, although the terms “first”, “second”, etc. may be used herein to describe various elements, components, regions, layers, and/or sections, these elements, components, regions, layers and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of exemplary embodiments.

In the drawing figures, the dimensions of layers and regions may be exaggerated for clarity of illustration. Like reference numerals refer to like elements throughout. The same reference numbers indicate the same components throughout the specification.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized embodiments (and intermediate structures) of exemplary embodiments. As such, variations from the shapes of the illustrations as a result, for exemplary, of manufacturing techniques and/or tolerances, are to be expected. Thus, exemplary embodiments should not be construed as limited to the particular shapes of regions illustrated herein but are to include deviations in shapes that result, for exemplary, from manufacturing. For exemplary, an implanted region illustrated as a rectangle will, typically, have rounded or curved features and/or a gradient of implant concentration at its edges rather than a binary change from implanted to non-implanted region. Likewise, a buried region formed by the implantation may result in some implantation in the region between the buried region and the surface through which the implantation takes place. Thus, the regions illustrated in the figures are schematic in nature and their shapes are not intended to illustrate the actual shape of a region of a device and are not intended to limit to scope of exemplary embodiments.

Unless otherwise defined, all terms (including technical and scientific terms) used herein have the same meaning as commonly understood by one of ordinary skill in the art to which exemplary embodiments belong. It will be further understood that all terms, such as those defined in commonly-used dictionaries, should be interpreted as having a meaning that is consistent with their meaning in the context of the relevant art and will not be interpreted in an idealized or overly formal sense unless expressly so defined herein. As used herein, expressions such as “at least one of”, when preceding a list of elements, modify the entire list of elements and do not modify the individual elements of the list.

When the terms “about” or “substantially” are used in this specification in connection with numerical values, it is intended that the associated numerical value include a tolerance of ±10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%. Moreover, when the words “generally” and “substantially” are used in connection with geometric shapes, it is intended that the precision of the geometric shape is not required but that latitude for the shape is within the scope of the disclosure. Although the tubular elements of the embodiments may be cylindrical, other tubular cross-sectional forms are contemplated, such as square, rectangular, oval, triangular, and others.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For exemplary, when a device structure (e.g., a memory cell structure or transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain exemplary embodiments of the present description.

Due to the biological makeup of corn, the starchy vegetable is grown on stalks and around a central, hardened core known as a cob. Although consuming corn directly off this cob may be desired in many household instances, there are many situations wherein it may be increasingly beneficial to remove corn kernels from the cob. Such instances may include for household or restaurant usage, and farming or canning purposes.

In many instances of household corn consumption, fresh, rather than canned, corn may be desired. This may be for a multitude of reasons, including for dietary or taste reasons. For example, many canned foods, including corn, may contain much higher levels of sodium than their fresh counterparts. This may be due to the addition of salt as a preservative in canned foods. Excessive sodium intake may have negative effects on the body, including increased blood pressure and chance of stroke or heart attack. Thus, the avoidance of such excess sodium may be desired in many instances to prevent such adverse effects. Additionally, fresh corn may be desired for taste or flavor reasons. Much of the time, fresh food, including corn, may have a sweeter and more pure taste, as opposed to canned foods. This may be for a multitude of reasons, including the lack of preservatives or other additions that may be present in canned or otherwise preserved foods.

Therefore, due to the aforementioned desire for fresh corn in many households, and the biological composition of the crop, corn may be consumed on the cob in many household instances. In some situations, such consumption may be desired. However, in many other instances, the removal of corn kernels from the cob may be necessary or desired for consumption in household settings. For example, when corn is to be used as a topping or within a dish, such as corn salsa or corn casserole, the corn must be removed from its cob before implementation into the recipe. In other instances, wherein a member of the household may be younger or have difficulty consuming corn directly from the cob due to external circumstances such as orthodontal procedures, corn kernels may be removed from the cob for ease of consumption.

Similar to the aforementioned desire for fresh corn in household settings, fresh corn may be desired opposed to canned or otherwise preserved corn in restaurant or eatery establishments. This may be due to a multitude of reasons, including health, taste, and business reasons. As mentioned above, canned foods such as corn may contain excess sodium due to preservation aiding additives. In many instances, the avoidance of such sodium may aid in the avoidance of diseases or health conditions such as high blood pressure. In addition to these health reasons, fresh corn may be used for its flavor benefits, as described above. In restaurant instances especially, such fresh taste may be extremely important for customer satisfaction and reviews. Along with health and taste reasonings, the use of fresh corn in restaurant or eatery establishments may pose benefits to the business. This may be due to increased customer satisfaction and reviews from exceptional taste, as mentioned above, or due to marketing associated with freshness. For example, the increasingly popular “farm to table” strategy in restaurant establishments may rely on the use of fresh foods such as corn and may bring in additional customers.

Because of the aforementioned benefits of using fresh corn in restaurants and its biological composition, corn must be either consumed directly off the cob or removed from the cob in many instances. Although the consumption of corn directly from its cob may be desired in a few restaurant or eatery circumstances, the corn must be removed in most instances. This may be due to a variety of reasons, such as recipe and professional reasons. When corn is used in recipes or as part of a dish in restaurants, it must be removed from the cob in order to be properly implemented into the dish. In other instances when corn is to be served as a side dish or on its own, it may be more professional to serve it off of the cob, allowing for increased ease of consumption.

In addition to aforementioned household and restaurant usage, corn may be used in farming or canning. When corn is canned, it must first be harvested and shucked, cooked, and then kernels must be removed. Kernels must be canned alone, without the cob. Therefore, it may be necessary in many farming and canning purposes to remove corn kernels from their cob.

For all of the above reasons, corn kernels may be removed from cobs in household, restaurant, and farming settings.

In many instances, the primary method for removing such kernels from cobs may be with manually, using a knife. Such a knife may be a serrated or continuous blade and may be used to scrape kernels from a cob. In such a method of removing kernels, manual force is required, which may be time-consuming, especially when there are multiple ears of corn that must be scraped. Additionally, the use of a straight knife allows for the possibility of an unclean cut. Instead of kernels being cut at their roots, they may be cut only halfway or less. This may result in a total lesser amount of corn, as well as a less aesthetically pleasing presentation. In instances such as restaurant usage, the amount and presentation of corn may be vital to the dish and the customer's enjoyment. Finally, the use of a straight knife may result in increased safety concerns. When using a knife to manually cut kernels, users may not have a barrier of protection between the blade and themselves. This may result in cuts or other injuries.

Therefore, it may be advantageous to provide additional apparatuses and devices that may aid in the removal of corn kernels from their central cobs. There currently exists a multitude of products available for purchase that may aid in this process, available for both household and industrial usage. One of these such apparatuses, used primarily in household and restaurant usage, may consist of a circular, serrated blade designed to fit around the core, or cob, of an ear of corn. Such a serrated blade may be driven down the length of the ear of corn, primarily by physical force, allowing the blade to cut the kernels close to their roots. In some embodiments, the blade may be attached to a set of horizontal beams, acting as handles, that may allow for users to push down without having to physically touch the blade. In other embodiments, the blade may simply be surrounded by a circular layer of plastic, aluminum, or other material for the user to hold as the blade is pushed down the cob. In still other embodiments, the blade and surrounding elements may contain an attached vessel wherein cut kernels may be stored. In these embodiments, the vessel may be emptied following the completion of the removal process.

In addition to the aforementioned circular blade apparatuses, some devices used in household or restaurant settings may consist of a curved or rounded blade that may act in a way similar to the knife, as described above. Such a rounded blade may more easily conform to the rounded shape of the cob, allowing for a cleaner cut in many instances. In many embodiments, the rounded blade may be attached to a handle such that users may not touch the blade itself. Such embodiments may be reminiscent of common peelers used for foods such as potatoes or apples. Embodiments may be driven down the length of the cob, again by physical force from users. In many instances, such apparatuses may necessitate multiple scrapes down the length of the ear, as the blade does not cover the entire cob. Thus, such apparatuses may result in the need for three or four instances of driving the blade down the cob, occurring at differing sides or angles. Similar to the circular blade mentioned above, some embodiments may contain an attached vessel wherein cut kernels may be stored. In these embodiments, the vessel may be emptied following the completion of the removal process.

In addition to the aforementioned exemplary embodiments of current devices available for household and restaurant use, there exists a multitude of products that may aid in stripping ears of corn on industrial scales. Some embodiments of such industrial corn strippers may be consisted of large components wherein multiple ears of corn may be inserted into the components. The corn may then pass through one or more circular rotating blades. The blades may cut around the cob in different directions, and cobs may be expelled at the opposite side of the device. The device may be motorized, and the cut corn kernels may be held within the center portion of the device, which may be serving as a storage vessel. The storage vessel may then be emptied following the completion of the removal process. Industrial corn strippers may exist in different fashions than this, but the use of motorized blades and ability to strip multiple ears at once is standard for most embodiments of such devices.

Although there exists devices and apparatuses for aiding in stripping corn kernels off the cob, as described above, such devices may not be preferred. For example, the physical force required to cut kernels in the first, circular blade, embodiment may put a strain on the user and be a time-consuming process. In some cases wherein users may have muscle strain or conditions such as arthritis, this method may cause unnecessary strain and pain. In other cases, users may not be able to use this method at all, due to the overwhelming physical effort and force required. Additionally, in some embodiments, there may not be a sufficient protective barrier present between the serrated blade and the user, which may pose significant safety concerns. Finally, the use of a serrated, opposed to a continuous, blade may result in unclean removal, and kernels may not be cut at their roots. This may result in a total lesser amount of corn, as well as a less aesthetically pleasing presentation. In instances such as restaurant usage, the amount and presentation of corn may be vital to the dish and the customer's enjoyment.

In other embodiments containing a rounded or curved blade and a handle, as described further above, much of the physical force required may be eliminated. However, such apparatus may still require physical force, as the blade may be physically brought down the cob at differing sides and angles. In addition, because the stripping process may be completed numerous times, this method may further prolong the stripping operation. Similar to the aforementioned circular blade and knife methods, the use of a serrated rounded blade in some embodiments may result in unclean or partial removal, which may result in a total lesser amount of corn, as well as a less aesthetically pleasing presentation. In instances such as restaurant usage, the amount and presentation of corn may be vital to the dish and the customer's enjoyment. Finally, this method may, again, pose a safety hazard to the user. In many embodiments, there may not be sufficient barriers between the user and the blade, and injuries may easily occur during the stripping or peeling process.

There exist issues with industrial corn strippers as well. First, many of the large, bulky industrial corn strippers that exist on the market come at a price too high for the average farmer or canner. Prices may make sense for larger farms or factories, but not for many instances beyond that. In addition, the motorized blade may pose significant safety concerns for the user. The quick-moving blades may not be fully protected, or there may not be a significant barrier between the blade and the user. Thus, cuts or other injuries may not be uncommon. Additionally, these machines can be flawed or messy in their cutting, as the blade may not be specifically tailored to the corn's biological structure. This may result in unclean cutting of kernels or cutting only parts of kernels. This can decrease the total amount of corn or decrease the presentation quality of corn. In canning and restaurant instances, this may have a significant negative impact on the customer's enjoyment of the meal or product. Lastly, in many embodiments, cut corn kernels may be stored in a storage vessel, requiring removal, or emptying every cycle or few cycles. This can prolong the process of using the device and may prevent a smooth stripping process from being achieved.

Therefore, it may be advantageous to provide a solution for removing corn kernels from cobs wherein the above mentioned problems with existing apparatuses may be solved. In such a solution, excessive physical force may not be required, allowing for easier stripping of ears of corn. Such a lack of physical force required may allow for users with arthritis or those who have difficulty with applying force to use the embodiment. Additionally, the lack of force required may allow for the embodiment to be used numerous times without placing physical strain on the user, making it suitable for all household, restaurant, and farming use. Preferred embodiments may also be equipped with adequate safety measures, with blade(s) that may be easily avoidable by the user, by means of covering or otherwise protecting the blade. Preferred embodiments may also be easily cleaned by means of a dishwasher or other method. Preferred embodiments may also be cost-effective, allowing for household and restaurant use without procuring excessive costs or expenses. Preferred embodiments may also be small and compact, allowing for use in all situations and eliminating the need for additional space for use of the apparatus. Finally, preferred embodiments may prevent the breakage or destruction of kernels that may exist with current solutions utilizing serrated blades.

Exemplary embodiments of such a solution may consist of a corn stripping apparatus wherein a tapered blade is used to easily remove corn kernels from their central cob, allowing for cleanliness, ease of use, and adequate safety of the user. Such a tapered blade may be circular in shape, with a top and bottom diameter, wherein the top diameter may be larger than the bottom diameter. Such a blade may be incorporated into a hollow portion of the apparatus known as a cob holder, wherein uncut portions of ears of corn are held as they are pushed towards the blade. Incorporation of the blade into the cob holder may be achieved through the use of end caps and end rings. In some exemplary embodiments, the blade may be placed within the end ring. An end cap may then be placed atop the blade, locking it into place and preventing excessive constraint or movement of the blade. The cob holder may further be comprised of a base ring located at the end of the portion. The base ring and end ring may be connected through a variety of means, such as horizontal side straps spanning the length of the cob holder. In some embodiments, the base ring may be coupled with a base cap such that it may be securely attached to the actuating device, described below. In some embodiments, such an attachment may be reversible, such that the base cap may be easily removed from the actuating device and remainder of apparatus for ease of cleaning.

In some exemplary embodiments, the aforementioned base cap may be coupled to an actuating device wherein the user may manually or automatically initiate the advancing of the corn to the blade. Such an actuating device may exist in a number of fashions. In one embodiment, for example, the device may consist of a trigger and frame, allowing the user to manually advance the pusher device, which is described below. In such embodiments, the device may consist of a frame wherein the rod may be inserted and held. Such a frame may have a protrusion that may be coupled to a spanner nut, which may, in turn, be coupled to the base cap. The device may further consist of a trigger which may be coupled to the frame by means of trigger pins. The device may further consist of a rod cam and spring which may facilitate the advancement of the rod and pusher device when the trigger is pulled. In other embodiments, the actuating device may be automated. In one embodiment, for example, the actuating device may consist of a rod drill bit attached to a power drill.

In many embodiments, the apparatus may further include a pusher device, which may be advanced following initiation of the actuating device. The pusher device may consist of a rod, on which all of the actuating device mechanisms may be mounted, as well as a pusher cap. When the actuating device is engaged, the pusher cap may be advanced forward, through the cob holder, and push the ears of corn towards the blade. Finally, the apparatus may include a reversal mechanism, wherein the rod may be pulled through the actuating device and reverted to its initial position. In some exemplary embodiments, this reversal mechanism may be defined by a thumb plate wherein pressure is lifted from the rod and it may be pulled back.

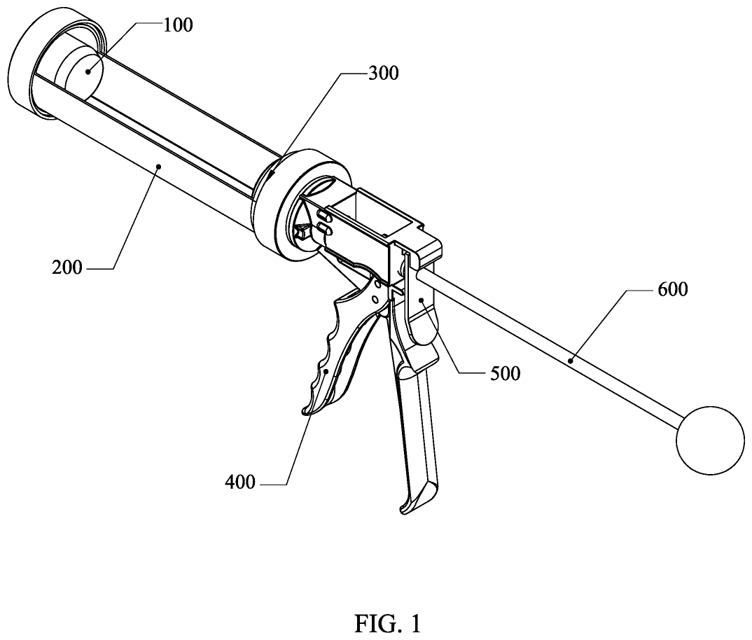

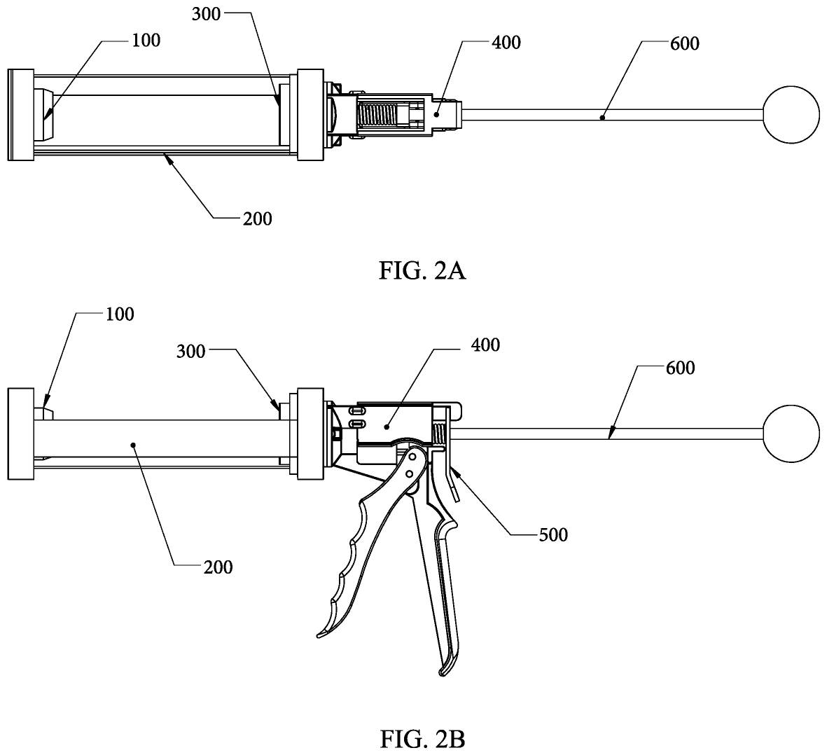

Turning now to FIG. 1, an isometric view of a corn stripping apparatus exemplary embodiment is shown. The corn stripping blade 100 is nested into the cob holder 200. The pusher device 300, actuating device 400, and reversal mechanism 500 are mounted upon a central rod 600. FIG. 2A shows a top view illustration of a corn stripping apparatus exemplary embodiment. The blade 100, cob holder 200, pusher device 300, and central rod 600 are shown, in addition to the inner mechanics of the actuating device 400. FIG. 2B shows a front view illustration of a corn stripping apparatus exemplary embodiment.

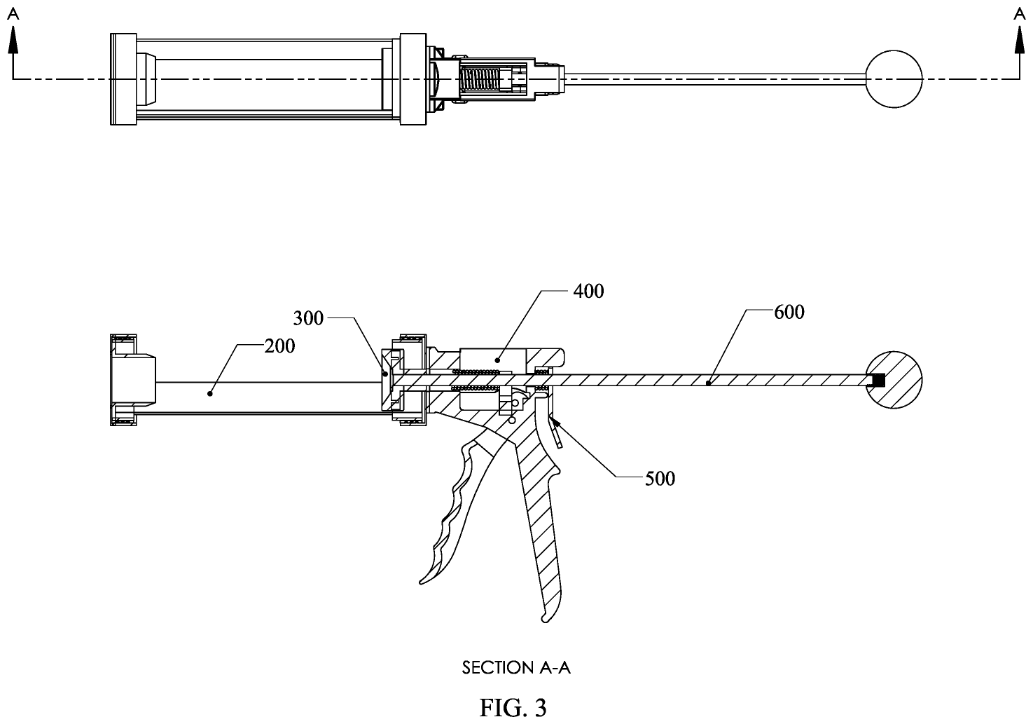

FIG. 3 is a full section view illustration of a corn stripping apparatus exemplary embodiment, showing the inner portions of the cob holder 200, pusher device 300, actuating device 400, reversal mechanism 500, and central rod 600.

Exemplary embodiments of the aforementioned blade, cob holder, actuating device, pusher device, and reversal mechanism are discussed in detail below.

The preferred embodiment of the provided corn stripping apparatus may first contain a blade for cutting corn kernels from their central cob. As stated above, many current solutions to removing kernels may do so via a serrated blade. Such serrated blades may, in many instances, result in unclean and imperfect stripping of corn kernels. This may be due to the texture of the blade, as such a serrated texture may not allow for the cutting of kernels at their base, and may instead cut them at their center, or at other locations on the corn kernel. As stated above, such an unclean cut may result in an overall lesser amount of corn, or a less aesthetically pleasing presentation. In many instances, particularly restaurant and eatery usage, such amount and presentation of corn may be vital to the consumer's enjoyment.

Therefore, due to the possible negative effects that may occur from the usage of serrated blades on corn kernels, the blade provided in one preferred embodiment of the corn stripping apparatus may be continuous. In other embodiments, the blade may be serrated.

In many embodiments of the corn stripping apparatus, the blade may be of a tapered circular geometry. Such a blade may exist in a number of fashions. In one embodiment, for example, the blade may be constructed in a funnel-like shape, with a lower diameter and an upper diameter, where the upper diameter may be greater than the lower diameter. In such embodiments, the bladed portion may exist at the lower diameter. In such embodiments, the upper diameter may be approximately equivalent to the inner diameter of the end cap or the holder's end ring. Exemplary embodiments of such end caps and holder end rings will be discussed in detail further below. This approximate equivalency may allow for the blade to fit adequately and comfortably within the end cap or end ring of the holder, allowing it to be easily secured into place without excessive room for movement or being under excessive pressure. Additionally, in such embodiments, the lower diameter may be approximately equivalent to or slightly larger than the average diameter of a corn cob. Such a lower diameter will allow the central cob from the ear of corn to pass through the blade easily, without excessive room for movement or excessive force being placed upon the cob.

In another embodiment, the blade may be constructed of two cylindrical portions that may be coupled together. In such embodiments, the lower cylindrical portion may have a lower diameter, while the upper cylindrical portion may have an upper diameter, where the upper diameter may be greater than the lower diameter. In such embodiments, the lower cylindrical portion may contain the bladed portion. In one exemplary embodiment, the upper and lower cylindrical portions may be coupled by means of welding. In another exemplary embodiment, the upper and lower cylindrical portions may be coupled by means of glue or another adhesive. In yet another exemplary embodiment, the upper and lower cylindrical portions may be constructed and formed unitarily. In still other exemplary embodiments, the upper and lower cylindrical portions may be coupled by means of any attachment methods. In such embodiments containing upper and lower cylindrical portions, the upper diameter may be approximately equivalent to the inner diameter of the end cap or the inner diameter of the holder's end ring, for the reasoning provided above. Exemplary embodiments of end caps and holder end rings will be discussed in detail further below. Additionally, the lower diameter may be approximately equivalent to or slightly larger than the average diameter of an ear of corn's central cob, for the reasoning provided above.

In other embodiments, the blade may consist of any geometry, with any number of circular portions, and any method of attachment used in coupling said circular portions. In most preferred embodiments, however, the blade may be tapered in nature, such tapered geometry occurring through any means. Such tapered geometry may allow for the prevention of kernel buildup when using the apparatus. In embodiments wherein the blade is not tapered, there exists a possibility that kernels will become lodged into the small space between the blade and the end cap. This may necessitate frequent cleaning of the device and may eliminate the possibility of clean and seamless usage, in addition to prolong use time. Thus, the tapered geometry of the blade may be preferred. In some embodiments wherein the blade is tapered, the kernels may easily slide off of the funnel-like shape, preventing aforementioned kernel build-up. In other embodiments, the upper cylindrical portion may facilitate such seamless movement of kernels.

In addition to the tapered geometry of the blade, each embodiment of the blade may consist of at least one cylindrical or circular portion wherein the diameter of said cylindrical or circular portion may be approximately equivalent to the average diameter of an ear of corn's central cob. This approximate equivalency may allow for the complete scraping of the ear of corn, as described further above. This diameter may be standardized to fit the majority of corn cobs.

Additionally, in some embodiments, blades may differ in sizes such that the lower diameter may be larger or smaller than the average corn cob size. Such differing sizes may exist such that abnormally large or small cobs may still be supported by the apparatus. Also, differing sizes of blades may support different types of corn. Most corn grown and consumed may be sweet corn, but there exists additional types and species of corn as well. For example, Dent corn, Flint corn, and Heirloom corn are all different types of corn and may serve differing purposes. Dent corn may be used in many animal feeds, as well as in grains and bourbons, due to its high starch and low sugar content. Flint corn may be used in flours and popcorn due to its high nutrition value. Heirloom corn refers to any number of non-mass produced corn that may consist of any number of species of types of corn. Because all of these types of corn may differ in their usage and biological presentation, they may additionally differ in the sizes of their cobs. Thus, it may be advantageous to provide a number of blade varieties that may fit a number of cob sizes, allowing many embodiments of a corn stripping apparatus to be used on a variety of types and sizes of corn. In some embodiments, even, blades may be significantly changed in size to support the stripping or peeling of crops such as potatoes or carrots.

Because the blade is physically touching and cutting corn kernels, it is largely possible that contamination and buildup of kernels may occur, even with the tapered shape of the blade. Additionally, juices from the corn kernels or other pieces of the ear of corn may become placed upon the blade, causing further contamination. Therefore, it may be advantageous to wash or clean the blade after use, either by means of a dishwasher or hand washing. In either instance, it may be easier to wash the blade independently of the other portions of the apparatus. This may be achieved through the reversible coupling of the blade to the rest of the apparatus, which will be discussed in detail further below.

Embodiments of such blades may be constructed of any material that may successfully cut kernels. In many embodiments, this material may be stainless steel, but could be any other material used in constructing and forming blades.

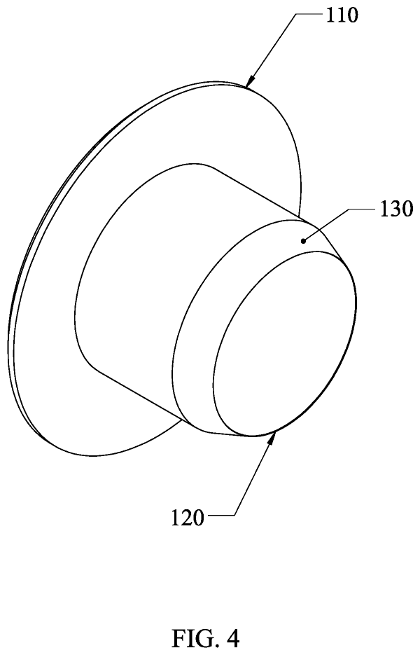

Turning now to FIG. 4, an isometric illustration of a blade exemplary embodiment is shown. The lower diameter 120 is directly below the bladed portion 130 and may have a diameter approximately equivalent to the average diameter of a corn cob such that it may completely cut kernels from their roots at the cob. The upper diameter 110 may have a diameter approximately equivalent to the end ring or inner end cap diameter such that it may fit securely into the end cap or end ring without excessive constraint or room for movement.

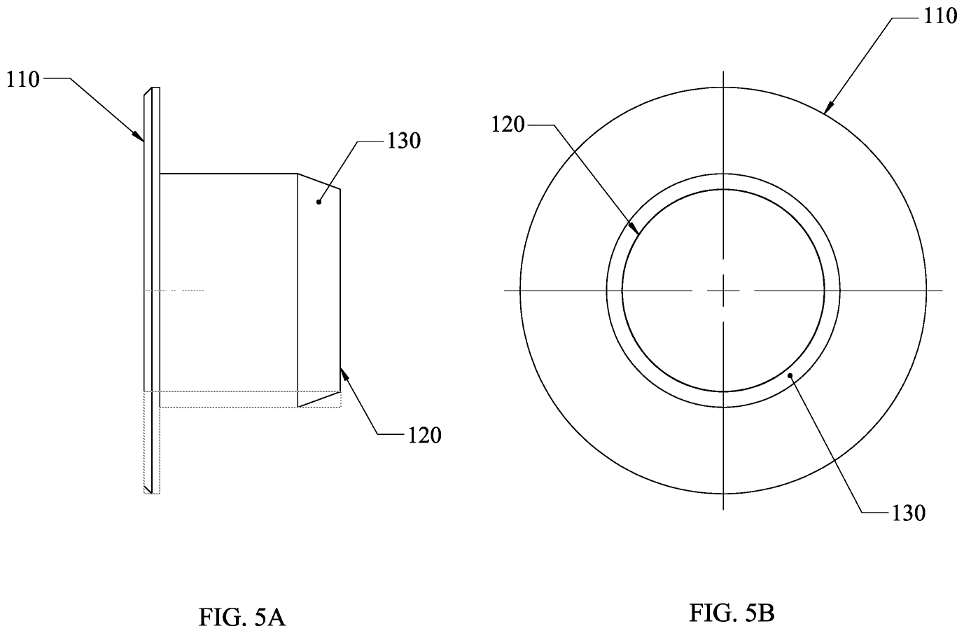

FIG. 5A shows a side view illustration of a blade exemplary embodiment, wherein the tapered or layered geometry of the blade is more easily shown. The upper diameter 110 leads to a portion with a lower diameter 120 and a bladed portion 130. FIG. 5B is a front view illustration of a blade exemplary embodiment, wherein the lower diameter 120, bladed portion 130, and upper diameter 110 are shown.

The preferred embodiment of the provided corn stripping apparatus may further contain a portion of the apparatus henceforth known as a cob holder, wherein ears of corn may be held and stripped. In some exemplary embodiments, cob holders may fully support ears of corn, where in other exemplary embodiments, support of ears of corn may be partially provided manually by the user.

In some exemplary embodiments, such a cob holder may be defined by a hollow cylindrical portion that may be of a size large enough to hold uncut sections of ears of corn as they are pushed towards the blade. In other exemplary embodiments, such a cob holder may be defined by a hollow rectangular portion that may be of a size large enough to hold uncut sections of ears of corn as they are pushed towards the blade. In yet other exemplary embodiments, such a cob holder may be defined by a hollow portion of any geometry, provided that the portion may be of a size large enough to fully hold uncut sections of ears of corn as they are pushed towards the blade. In many embodiments, the hollow portion may be of a length and width approximately equivalent to the average length and width of an ear of corn, which may allow for a size large enough to fully hold uncut sections of ears of corn as they are pushed towards the blade. In many embodiments, the cob holder may exist at the front end of the device, wherein the blade may be incorporated into the holder's structure.

The cob holder may, in many embodiments, be the only portion of the entirety of the corn stripping apparatus that may physically hold or touch the corn. Thus, it is largely possible that kernel build-up may occur, and the cob holder may become contaminated or dirty from the kernels. Additionally, any juices from kernels or other pieces from the ear of corn may become placed upon the cob holder, causing further contamination of the apparatus. Therefore, it may be advantageous to clean the cob holder, removing any traces of corn kernels and reverting the apparatus to its previous, clean state. Such cleansing of the cob holder may occur by means of hand washing or dishwasher. In either instance, it may be advantageous to provide an embodiment wherein the cob holder may be easily removable from the remainder of the apparatus, allowing it to be easily washed or cleaned independently, either by means of a dishwasher or hand washing. Such easy removal of the cob holder may be achieved through a variety of means. In some embodiments, for example, an end cap may be located directly between the cob holder and the actuating device. Such an end cap may provide a reversable method for the cob holder to be incorporated into the apparatus, such that the cob holder may be removed from the end cap and the apparatus, allowing for it to be independently washed. Exemplary embodiments of end caps are discussed in detail further below.

In some exemplary embodiments, the hollow body of the cob holder may be consisted of two circular ends which may be linked together by means of two or more horizontal side straps. Such circular ends may henceforth be known as rings, with the top end referred to as an end ring, and the bottom end referred to as a base ring. In some embodiments wherein the body is to be cylindrical, the end and base rings may be circular. In other embodiments wherein the body is to be rectangular, the end and base rings may be rectangular. In yet other embodiments, the end and base rings may be of any geometry.

The end ring of the cob holder may, in many exemplary embodiments, be constructed such that the blade may be held by the end ring. In some embodiments, the blade may be supported by the collective construction of the end ring and the end cap, which is discussed in detail further below. Such blade support may be located at the front end of the apparatus such that ears of corn may approach the blade while the cob is pushed out of the front end of the apparatus. Therefore, in many embodiments, the end cap may be of a geometry such that the blade may be at least partially supported by the end cap. Because of the circular shape of the blade, as described further above, this may necessitate a circular end ring. In such embodiments wherein the end ring may be circular, the diameter of the end ring may be approximately equivalent to the upper diameter of the blade. This approximate equivalency may allow for the blade to be adequately supported by the end ring, without constraint or excessive force being placed on the blade, or excessive room for the blade to move.

In some embodiments, the end ring may be threaded, along with the end cap, for easy attachment and removal. Such end ring threads may be of any size and profile, providing that they may fit with the threads on the end cap. In one embodiment, threaded portions of the end rings may be constructed separately and coupled to end ring via welding. In another embodiment, threaded portions of the end ring may be constructed separately and coupled to the end ring via glue or other adhesives. In yet another embodiment, threaded portions of the end rings may be constructed separately and coupled to the end ring via bolting or other forms of mechanical attachment. In yet another embodiment, threaded portions may be unitarily constructed with the ends rings. In still other embodiments, threaded portions of the end ring may be constructed separately and coupled to the end ring via any form of attachment.

The base ring may be constructed similarly to the end ring and may be of any size. In preferred embodiments, the base ring may be of a diameter or size equivalent to that of the end ring, allowing for a more consistent shape of the overall holder. In embodiments wherein the base ring is larger than the end ring, for example, side straps may be tapered outwards such that they may fully support both the end and base rings, and the holder may be shaped in a cone-like fashion. In other embodiments wherein the base ring is smaller than the end ring, side straps may be tapered inwards such that they may fully support both the ends and base rings, and the holder may be shaped in a cone-like fashion. In such embodiments, if the base ring is not of a diameter large enough to fully support an average cob of corn, the holder may be unable to support the corn and may not be useful. Therefore, it may be advantageous to construct a base ring of a size similar, or equivalent, to the end ring. Such sizing may also ease the construction process, as no modifications may be made to the base ring, allowing it to be fully identical to the end ring.

Similar to the end ring, in some embodiments, the base ring may be threaded, along with the base cap, for easy attachment and removal. Such base ring threads may be of any size and profile, providing that they may fit with the threads on the base cap. In one embodiment, threaded portions of the base rings may be constructed separately and coupled to base ring via welding. In another embodiment, threaded portions of the base ring may be constructed separately and coupled to the base ring via glue or other adhesives. In yet another embodiment, threaded portions of the base rings may be constructed separately and coupled to the base ring via bolting or other forms of mechanical attachment. In yet another embodiment, threaded portions may be unitarily constructed with the base rings. In still other embodiments, threaded portions of the base ring may be constructed separately and coupled to the base ring via any form of attachment.

In one embodiment, end and base rings may be constructed of aluminum. In another embodiment, end and base rings may be constructed of stainless steel. In yet another embodiment, end and base rings may be constructed of nylon. In still other embodiments, end and base rings may be constructed of any material such that the material may be firm and strong enough to support the side straps and the cob of corn. In some embodiments, the corn holder may not contain end or base rings, and side straps may couple fully to end and base caps. In other embodiments, end and base rings may be of a demi-circle or semi-circle geometry and may only define a partial cylinder when coupled with the side straps described below. In still other embodiments wherein end and base rings are not to be of a circular geometry, end and base rings may still be of a partial shape geometry, meaning that end and base rings are not fully connected and may not contain a top portion.

Preferred embodiments may further contain horizontal side straps which may serve as links between the end and base rings. In some embodiments, such side straps may be flat, rectangular connections. In other embodiments, such side straps may be circular connections. In yet other embodiments, side straps may be cylindrical connections. In still other embodiments, side straps may be of any geometry such that they may fully support end and base rings and form a cohesive holder structure.

In some preferred embodiments, holders may contain two side straps located on opposing sides of end and base rings. In such embodiments, there may be adequate space such that users may physically grab corn cobs and aid in forcing them through the blade. Also in such embodiments, there may be adequate space such that users may easily place corn cobs into the holder apparatus. In other embodiments, holders may contain any number of side straps located at any points or sides of end and base rings, such that there may be adequate space for users to place corn cobs into the holder apparatus, and such that there may be adequate support of the end and base rings. However, in such embodiments, cut kernels may more easily become lodged or stuck on the side straps instead of falling directly through the spaces between side straps. In still other embodiments, holders may be fully enclosed or contain any number of side straps if the opening on the end cap is large enough for an uncut cob of corn to be inserted into the holder through the opening on the end cap. In such embodiments, users may be unable to physically aid in feeding corn cobs through the blade. Also in such embodiments, cut corn kernels may be unable to fall through spaces between side straps, resulting in a need for the apparatus to be emptied of corn kernels periodically.

In one embodiment, the holder apparatus may further contain smaller, vertical side straps that may connect two or more primary horizontal side straps. Such smaller vertical side straps may provide additional support to the apparatus. However, such vertical side straps may prevent cut corn kernels from falling freely through spaces between side straps and may require the apparatus to be emptied of corn kernels periodically. In embodiments wherein vertical side straps are to be included at multiple areas on the apparatus, users may be unable to physically aid in feeding the cob through the blade. Additionally, the opening on the end cap may be used as the method for inserting uncut corn cobs, so such embodiments may necessitate openings on the end cap that may be large enough for fully uncut corn cobs.

In some preferred embodiments, side straps may be of any size such that they may provide adequate support to end and base rings and such that they may allow for users to physically place corn cobs into the holder and aid in feeding them through the blade. In other embodiments, side straps may be thinner and may exist in an increased number such that adequate support is still being provided. In yet other embodiments, side straps may be thicker, if the opening on the end cap is large enough for users to insert the uncut corn cob. In such embodiments, thicker side straps may allow cut kernels to more easily remain lodged or stuck on the side straps, which may necessitate emptying the apparatus periodically.

In one embodiment, side straps may be constructed and attached to end and base rings by means of welding. In another embodiment, side straps may be constructed and attached to end and base rings by means of glue or other adhesives. In another embodiment, side straps may be constructed and attached to end and base rings by means of screws, bolts, or other forms of mechanical attachment. In yet another embodiment, side straps may be unitarily constructed with end and base rings. In still other embodiments, side straps may be attached to end and base rings using any method of attachment. In embodiments wherein side straps are not unitarily attached to end and base rings, connections may be reversed such that side straps may be easily removed from end and base rings. In such embodiments, side straps and end and base rings may be washed or cleaned independently.

In some embodiments, side straps may be constructed and formed of aluminum. In other embodiments, side straps may be constructed and formed of stainless steel. In yet other embodiments, side straps may be constructed and formed of stainless steel. In still other embodiments, side straps may be constructed and formed of any material such that the material may be solid and strong enough to fully support end and base rings.

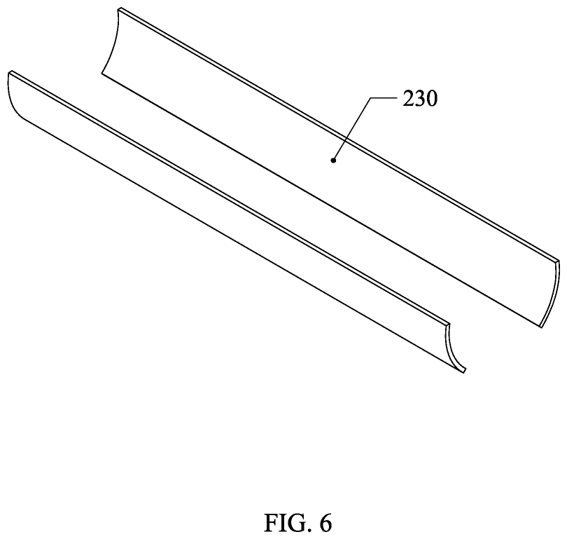

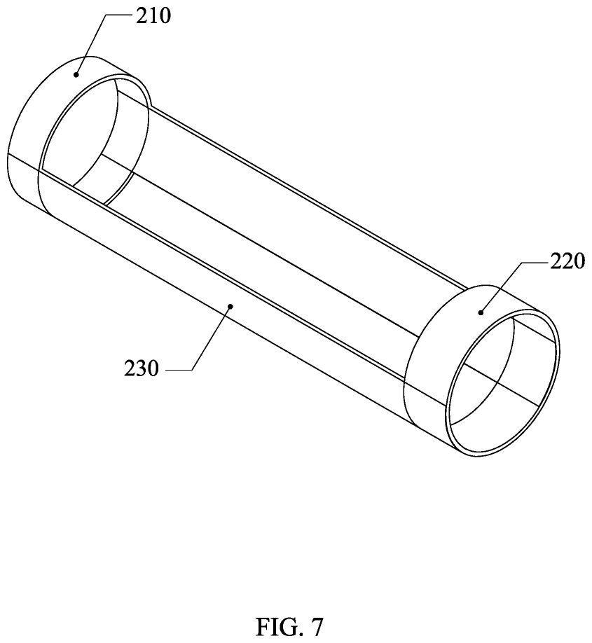

Turning now to FIG. 6, an isometric illustration of side strap exemplary embodiments is shown. In such a figure, side straps 230 are located at opposing sides and do not contain any additional vertical side straps or other features. FIG. 7 shows an isometric illustration of the base portion of a cob holder exemplary embodiment. Such a base portion may contain an end ring 210 and base ring 220, which may be connected by means of horizontal side straps 230.

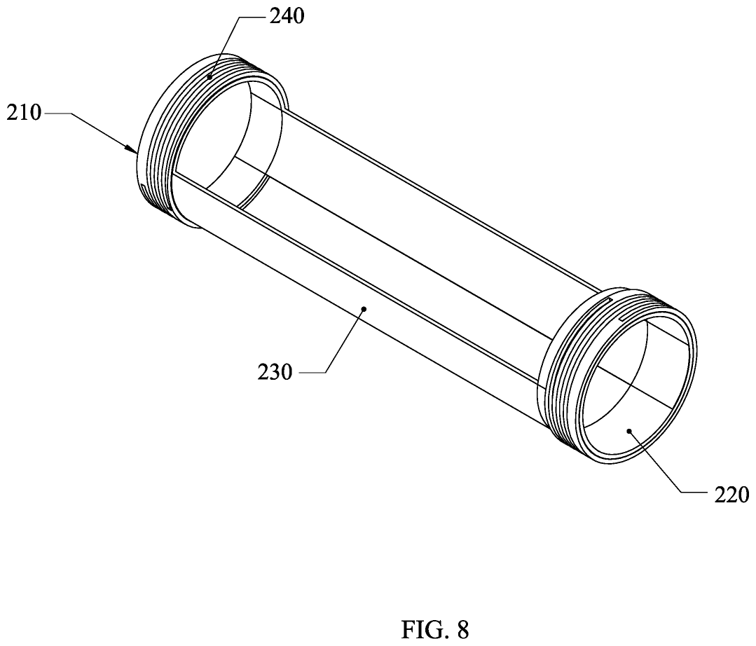

FIG. 8 shows an isometric illustration of the base portion of a cob holder exemplary embodiment, with additional threaded portions shown. The end ring 210 and base ring 220 are connected by horizontal side straps 230, with threaded portions 240 on the end ring 210 and base ring 220. Such threaded portions may be constructed separately from the end and base rings and attached using any method of attachment or may be constructed unitarily with the end and base rings. Threaded portions may be included for ease of attachment with the end and base caps.

Preferred embodiments may further contain a barrier to the holder known henceforth as an end cap. Such an end cap may be located at the front of the apparatus and may serve as a receptacle in which the blade may be held and secured, and may provide an additional degree of safety, as it is acting as a barrier between the blade and the user. The end cap may be of a diameter or size equivalent to that of the upper portion of the blade. Such sizing may allow for the blade to easily fit within the end cap without excessive constraint or room for movement. The blade may be easily removed from the end cap, allowing for it to be washed or cleaned of excess corn kernels independently. In one embodiment, such an end cap may be constructed and formed of nylon. In another embodiment, such an end cap may be constructed and formed of rubber. In yet another embodiment, such an end cap may be constructed and formed of plastic. In still other embodiments, such an end cap may be constructed and formed of any material such that the material is firm enough to fully support the blade and provide a full barrier to the holder apparatus, yet soft enough to allow users to easily engage with the end cap.

In many embodiments, the end cap may be of the same geometry as the end ring. If the end ring is of a circular shape, for example, the end cap may also be of a circular shape. This may allow for the end cap and end ring to be more easily coupled together. In embodiments wherein the end cap and end ring are not of the same geometry, there may be increased difficulty in attaching the end cap to the end ring. In one embodiment, the end cap may be circular. In another embodiment, the end cap may be rectangular. In yet other embodiments, the end cap may be of any geometry such that it may be the same geometry as the end ring, or that it may easily be attached to the end ring. The geometry of the end cap may also allow for the definition of a hole, as described below. The geometry of the end cap may also allow for the blade to be easily secured by the end cap, or by the end cap and end ring.

In many preferred embodiments, the end cap may define a hole, as mentioned above. Such a hole may be included such that the cob may be provided some way to escape the apparatus once the cutting process is complete, or underway. As the actuating device is initiated and the cob is pushed forward towards the blade, the cob after being cut is continuously brought forward and must have some way to escape the apparatus. The aforementioned hole may provide for that method of cob escape and removal. In one embodiment, such a hole may be circular. In another embodiment, such a hole may be rectangular. In yet other embodiments, such a hole may be of any geometry such that it may easily be defined by the end cap, and such that the cob may easily fit through the hole without constraint. In many embodiments, the hole may be formed with a diameter that is slightly larger than the average corn cob after being cut. Such sizing may allow for the cob to easily pass through the hole once cut, without constraint. In other embodiments, the hole may be formed with a diameter that is slightly larger than the average corn cob before being cut. This sizing may allow for the cob to easily pass through the hole once cut, in addition to allowing the entire uncut cob to be inserted into the holder apparatus through the hole. Such a large hole may be particularly advantageous in embodiments wherein multiple side straps are used or extremely thick side straps are used, as described above.

In some embodiments, the end cap may be threaded, along with the end ring, such that it may be easily and reversibly attached to the end ring. Such reversible attachment may allow for the blade and the end cap to be easily removed. This removal may allow for the blade, along with the end ring, side straps, and base ring, to be washed or cleaned independently. Aforementioned threads may be of any size or profile such that they may easily fit with the threads located on the end ring. In other embodiments, end caps and rings may not be threaded, and the connection may be secured through other means.

In some embodiments, end caps may not be included. In such embodiments, the apparatus may contain some other method for securing the blade. In one embodiment, for example, the top portion of the blade may be threaded along with the end ring such that the blade may be easily and reversibly attached to the end ring. In another embodiment, the end ring may be of a size such that the blade may be easily secured without the need for threads. In another embodiment, the blade may be welded to the end ring such that it is unitarily attached to the holder. In yet another embodiment, the blade may be attached to the end ring via glue or another adhesive. In still another embodiment, the blade may be attached to the end ring via bolting or another form of mechanical attachment. In other embodiments, the blade may be temporarily or permanently coupled to the end ring using any form of attachment. In embodiments wherein the attachment is permanent and not reversable, the blade may not be able to be washed independently, which may necessitate the careful handwashing of the entire holder apparatus. Additionally, in some embodiments where end caps are not included, there may be increased safety concerns for the user, as there may not be a barrier around the blade.

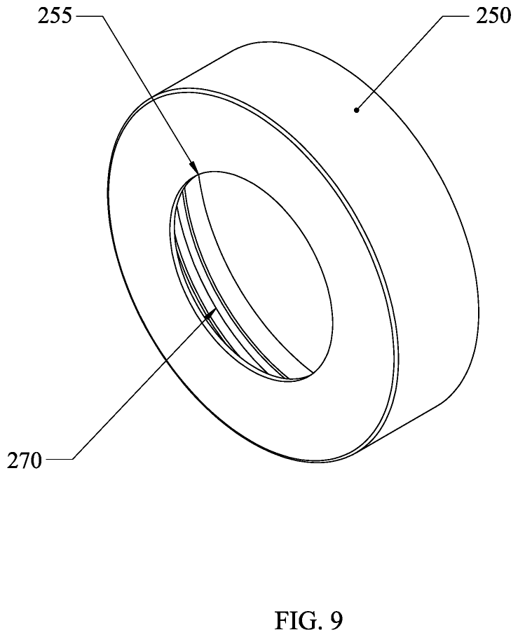

Turning now to FIG. 9, an isometric view of an end cap exemplary embodiment is shown. The end cap 250 may in many embodiments define a cavity 255, which may be of a diameter approximately equivalent to the average diameter of a corn cob, such that the corn cob may easily pass through the cavity during and after the cutting process without excessive constraint. The end cap 250 may further contain an inner threaded portion 270, which may be included along with end ring threads to facilitate an easier and more attachment of the end cap to the end ring.

In addition to the aforementioned end cap, many preferred embodiments may contain a similar barrier located at the end of the holder apparatus known henceforth as a base cap. Such a base cap may provide a barrier between the holder apparatus and the actuating device and may be of a diameter or size approximately equivalent to the base ring. Such a size may allow for the base cap to be more easily attached to the base ring and the rest of the holder apparatus. The base cap may allow for the base ring, and the rest of the holder apparatus, to be easily removed from the actuating device and the rest of the corn stripping apparatus. In one embodiment, the base cap may be constructed and formed of nylon. In another embodiment, the base cap may be constructed and formed of rubber. In yet another embodiment, the base cap may be constructed and formed of plastic. In still other embodiments, the base cap may be constructed and formed of any material such that the material is firm and solid enough to hold the base ring or side straps, but soft enough such that users may physically engage with the base cap.

In one embodiment, the base cap may be circular. In another embodiment, the base cap may be rectangular. In yet other embodiments, the base cap may be constructed of any geometry such that it may be adequately coupled to both the base ring and the actuating device. The base cap may be coupled to the actuating device via a number of methods. In one embodiment, the base cap may be coupled to the actuating device via a spanner nut, as will be discussed in detail further below. In another embodiment, the base cap may be coupled to the actuating device via glue or another adhesive. In yet another embodiment, the base cap may be coupled to the actuating device via bolting or other forms of mechanical attachment. In still other embodiments, the base cap may be coupled to the actuating device via any form of secure attachment.

In many preferred embodiments, the base cap may define a hole. Such a hole may allow for the apparatus' rod to pass through the base cap. The rod, as discussed in detail further below, may hold the pusher device which may bring the corn cob forward towards the blade. Therefore, as the pusher device needs to be located inside the holder portion at many points, the rod must pass through the barrier between the actuating device and holder portion, which may be achieved through the aforementioned hole in the base cap. In one embodiment, the hole may be circular in geometry. In another embodiment, the hole may be rectangular in geometry. In yet other embodiments, the hole may be of any geometry such that the rod may pass through. The hole may be of a diameter or size approximately equivalent to or slightly larger than that of the rod. Such a size may allow for the rod to pass through the hole without excessive constraint or room for movement.

In some embodiments, the base cap may be threaded, along with the base ring, such that it may be easily and reversibly attached to the base ring. Such reversible attachment may allow for the base ring and holder apparatus to be easily removed. This removal may allow for the holder apparatus to be washed or cleaned independently of the remainder of the corn stripper. Aforementioned threads may be of any size or profile such that they may easily fit with the threads located on the end ring. In other embodiments, base caps and rings may not be threaded, and reversible connections between the two may be secured through other means. In still other embodiments, connections may not be reversible, which may not allow for the holder to be washed independently and may necessitate careful hand-washing of the entire apparatus.

In some embodiments, base caps may not be included. In such embodiments, the holder apparatus may be directly coupled with the actuating device. In one such embodiment, the base ring of the holder may be coupled with the frame of the actuating device via welding. In another embodiment, the base ring of the holder may be coupled with the frame of the actuating device via glue or another adhesive. In yet another embodiment, the base ring of the holder may be coupled with the frame of the actuating device via bolting or another form of mechanical attachment. In still other embodiments, the base ring of the holder may be coupled with the frame of the actuating device via any form of attachment such that the rod or pusher device may be easily brought through the base ring. This may necessitate a different geometry for the base ring, for example, a partially enclosed cylinder with only a small hole for the rod may be used as a base ring. In embodiments wherein base rings are not to be included, however, the holder apparatus may not be removed from the remainder of the corn stripper, which may necessitate careful hand-washing of the entire apparatus as opposed to independent washing or cleaning of the holder.

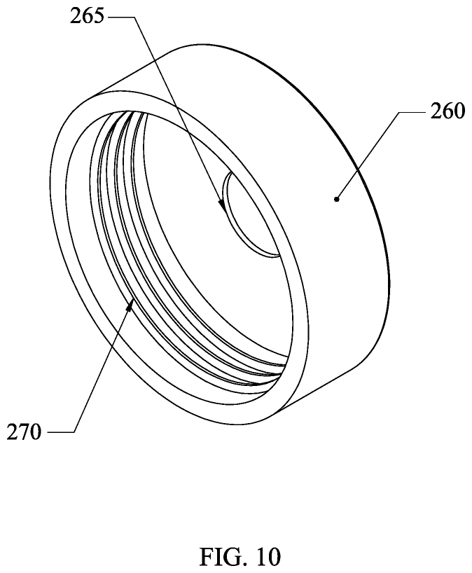

Turning now to FIG. 10, an isometric illustration of a base cap exemplary embodiment is shown. The base cap 260 may in many embodiments define a cavity 265, which may be of a diameter approximately equivalent to the diameter of the apparatus' central rod, such that the rod may pass through the base cap into the cob holder portion without excessive constraint or room for movement. Exemplary embodiments of base caps may further include inner threaded portions 270, which may be included along with threaded portions on the base ring to facilitate easier and more secure attachment to the base ring.

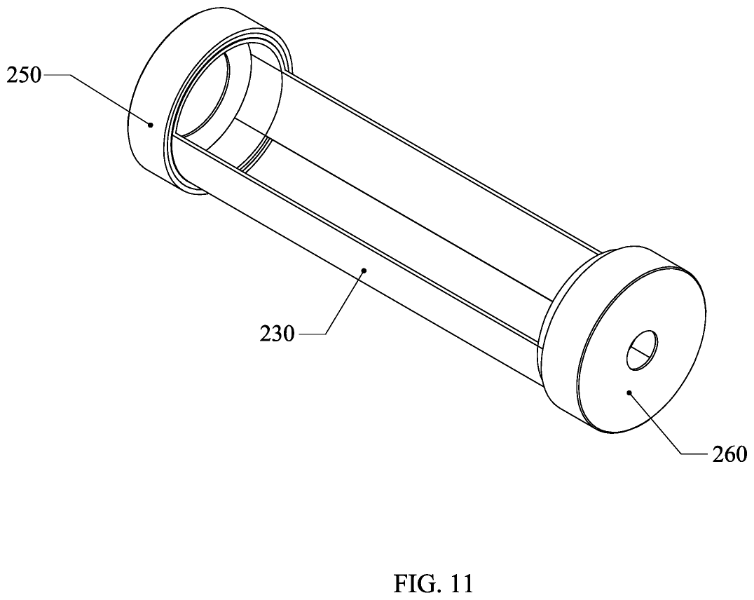

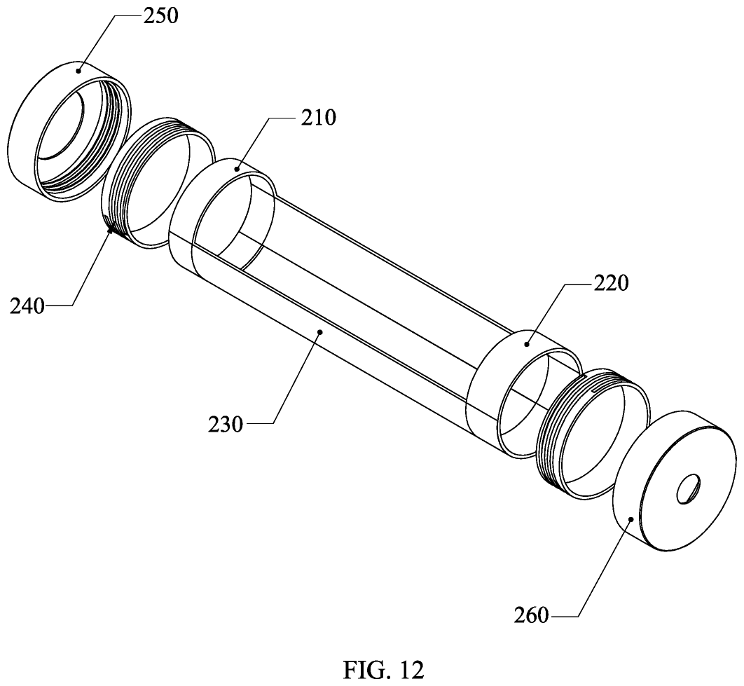

FIG. 11 shows an isometric illustration of a completed cob holder, without the corn stripping blade. The end cap 250 is placed over the end ring, which may be connected to the base ring by means of horizontal side straps 230. The base cap 260 is placed over the base ring. A more complete construction of a cob holder exemplary embodiment is shown in FIG. 12 via an isometric exploded view of the apparatus. As shown, horizontal side straps 230 connect end rings 210 and base rings 220. Threaded portions 240 may fit over end rings 210 and base rings 220. The end cap 250 may then fit over the end ring and threaded portion, while the base cap 260 may fit over the base ring and threaded portion.

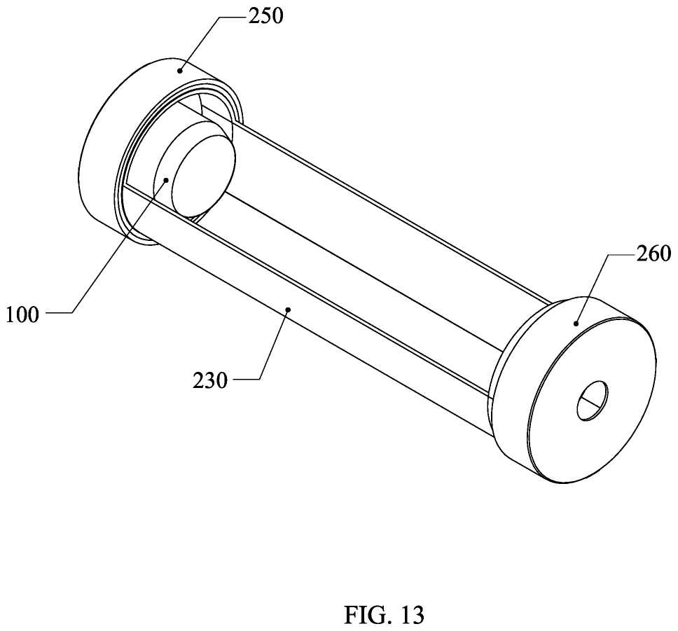

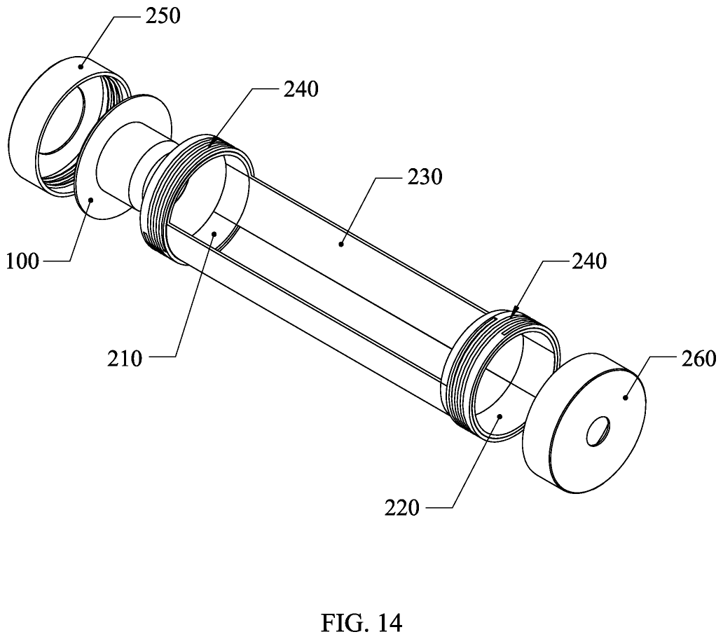

FIG. 13 shows an isometric illustration of a cob holder exemplary embodiment, containing the blade. The blade 100 is nested within the end ring and end cap 250, which is connected to the base ring and base cap 260 by horizontal side straps 230. A more complete construction of a cob holder exemplary embodiment with a blade is shown in FIG. 14 via an isometric exploded view of the apparatus. As shown, the blade 100 fits into the end ring 210. The end cap 250 may then attach to the end ring 210 via threaded components 240, fully enclosing the blade and protecting users from injuries sustained by direct access to a blade. The reversable attachment of the end cap and end ring may allow for the blade to be removed and washed independently. Similar to other figures, side straps 230 connect the end ring 210 to the base ring 220, and the base cap 260 is attached to the base ring 220 via threaded components 240.

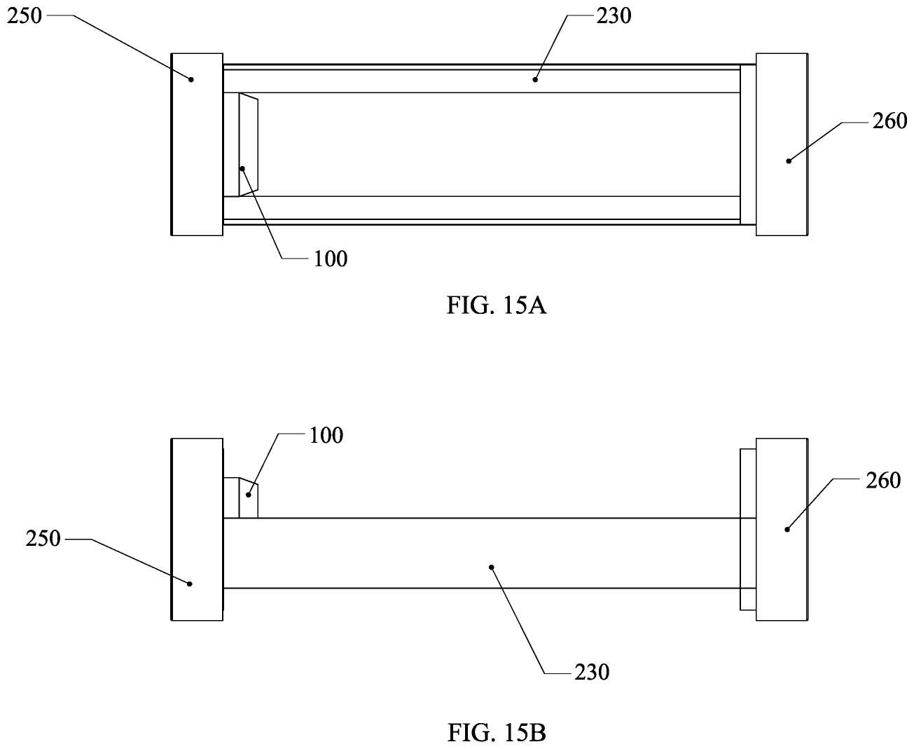

FIG. 15A shows a top view illustration of a cob holder exemplary embodiment, wherein the end cap 250, side straps 230, base cap 260, and blade 100 are shown. FIG. 15B shows a front view illustration of a cob holder exemplary embodiment, wherein the end cap 250, side straps 230, base cap 260, and blade 100 are shown.

The corn stripping apparatus may further contain a portion known henceforth as the pushing device. Exemplary embodiments of such a pusher device may be driving components of the apparatus that may push uncut portions of the ear of corn towards the blade to become cut. In many embodiments, such a pusher device may be engaged by the initiation of the actuating device. Thus, in such embodiments, the pusher device may be required to pass through the actuating device, or the section of the apparatus containing the actuating device. Additionally, as the ear of corn may be contained within the cob holder portion of the apparatus, the pusher device may be required to pass through the cob holder, allowing it to have a physical impact on the uncut ear of corn. In some embodiments, the user of the apparatus may physically aid in bringing the corn towards the blade, by holding and supporting the ear and applying additional pressure to bring it forward. However, the vast majority of pressure placed on the corn, and in turn the majority of the force driving the corn towards the blade, may come from the pushing device.

The pushing device may first consist of a rod, around which many components will be surrounded. In one embodiment, such a rod may be of a straight, cylindrical geometry. In another embodiment, such a rod may be of a straight, rectangular geometry. In another embodiment, such a rod may be of a curved cylindrical geometry. In yet another embodiment, such a rod may be of a curved rectangular geometry. In still other embodiments, such a rod may be of any geometry wherein the rod may allow for a variety of components to be placed around the rod, including many components of the actuating device.

The aforementioned rod may be of any diameter such that it may provide adequate support and such that it may not interfere with the user's usage of the apparatus. If the rod were to be too large, for example, the user may have difficulty initiating the actuating device. If the rod were to be too small, however, it may not be strong or firm enough to fully push the remainder of the pushing device and drive the uncut ear of corn towards the blade. In some preferred embodiments, the rod may be of a length approximately equivalent to the length of the holder. This sizing may allow for the rod and corresponding pushing device to begin at a position wherein the pusher is located at the back end of the holder, and end at a position wherein the pusher is located at the front end of the holder. Because the ear of corn may be of a length approximate to the holder, this may allow for the pusher and rod to push the entire length of the corn to the blade.

In some embodiments, the back end of the rod may be at least partially threaded, in addition to the comfort grip, for easy coupling with the comfort grip, as discussed below. Such threads may be of any size or profile such that they may fit with the threads on the comfort grip. The threaded portion of the rod may not exceed more that about an inch, which may be enough room to allow for coupling with the comfort grip. Similarly, in some embodiments, the front end of the rod may be at least partially threaded, along with a portion of the pusher cap, for easily coupling with the pusher cap, as discussed further below. Such threads may be of any size or profile such that they may fit with the threads on the portion of the pusher cap. The front threaded portion of the rod may not exceed more than about an inch, which may be enough room to allow for coupling with the pusher cap.

In one embodiment, the rod may be constructed and formed of aluminum. In another embodiment, the rod may be constructed and formed of stainless steel. In yet other embodiments, the rod may be constructed and formed of any material such that the rod may be firm and solid enough to fully support a multitude of components that may be placed on the rod.

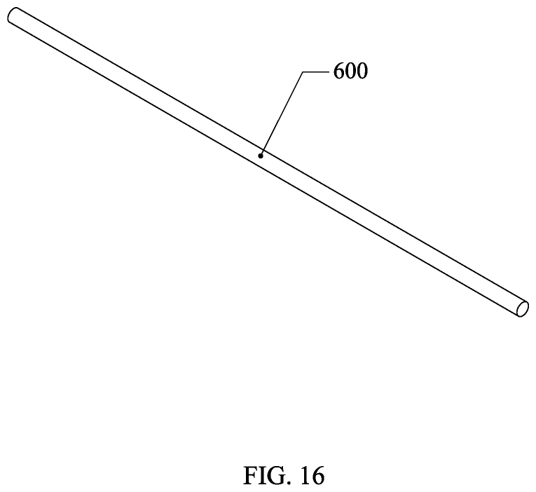

Turning now to FIG. 16, an isometric illustration of a straight rod exemplary embodiment is shown. The central rod 600 may not be straight in other embodiments.

The pusher device may further include a comfort grip located at one end of the rod. Such a grip may exist for the user's comfort and may ease the user in gripping and using the apparatus. In one embodiment, the grip may be spherical in geometry. In another embodiment, the grip may be tapered in geometry. In yet other embodiments, the grip may exist in any shape or geometry such that it may provide sufficient comfort and grip to the user.

In some embodiments, the grip may at least partially define a hole. Such a hole may aid in the coupling of the rod with the comfort grip. For this reason, the hole may be of a diameter approximately equivalent to the rod's diameter. In one embodiment, the rod may fit into the hole and establish a secure and direct connection without the need for any other attachment. In another embodiment, the rod may be fit into the hole with glue or another adhesive such that it may be fully secured. In yet another embodiment, the hole may be threaded along with the end of the rod such that the grip may be easily and securely coupled with the rod. Such threads may be of any size or profile such that they may easily fit with the threads on the rod. In still other embodiments, the hole and corresponding grip may be coupled with the rod by any form of attachments.

In some embodiments, the comfort grip may not define a hole. In one of these such embodiments, the grip may be directly coupled to the rod by means of glue or another adhesive. In another embodiment, the grip may be directly coupled to the rod by means of bolting or other forms of mechanical attachment. In yet other embodiments, the grip may be directly coupled to the rod by means of any form of attachment.

In one embodiment, the comfort grip may be constructed and formed of rubber. In another embodiment, the comfort grip may be constructed and formed of nylon. In yet other embodiments, the comfort grip may be constructed and formed of any material such that the material is soft enough to provide comfort to the user when using the apparatus. In some embodiments of the apparatus, a comfort grip may not be included. In such embodiments, the user may experience some discomfort when handling the end of the apparatus.

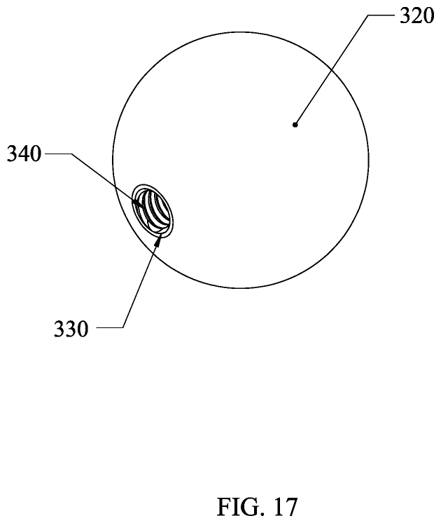

Turning now to FIG. 17, an isometric illustration of a comfort grip exemplary embodiment is shown. The comfort grip 320 may define a cavity 330 that may be of a diameter approximately equivalent to the diameter of the central rod, such that the rod may easily fit into the cavity without excessive constraint or room for movement. In some embodiments, the comfort grip may contain a threaded portion 340 on the inner portion of the cavity. In such embodiments, the central rod may be partially threaded as well, to ensure full and secure coupling of the two components.

The pusher device may further include a portion known henceforth as the pusher cap. The pusher cap may be the portion of the apparatus that is driven by the actuating device. Such a pusher cap may begin at a location at the base of the holder, by the base of the uncut ear of corn. As the actuating device is initiated, the pusher cap may be driven forward, bringing the uncut portion of the ear of corn towards the blade to be cut. The pusher cap may apply pressure to the base of the ear of corn only.

In some embodiments, such a pusher cap may contain a flattened portion. Such a flattened portion may be the portion which may have direct contact with the base of the ear of corn and may allow for even pressure to be placed upon the base of the ear of corn as the actuating device is initiated. Such even pressure is important for the ear of corn to be brought towards the blade at a consistent speed, which may allow for more even and consistent cutting. In other embodiments, the pusher cap may not contain a flattened portion, and may instead be completely spherical or circular in geometry. In such embodiments, the pressure placed on the ear of corn may not be as even or consistent as desired.

In some embodiments, the pusher cap may be consisted of a shallow tapered portion leading to a flattened portion. The cap may be circular in geometry and may contain a larger diameter tapered down to a smaller, flat circle located at the bottom of the tapered portion. The tapered portion may be open such that the flattened portion is the only portion that may apply pressure on the base of the ear of corn, for the reasoning provided above. The cap may then include a lower extrusion. Such a lower extrusion may aid in coupling the pusher cap to the rod, which will be discussed in detail below. In one embodiment, the lower extrusion may be of a cylindrical shape. In another embodiment, the lower extrusion may be of a rectangular shape. In yet other embodiments, the lower extrusion may be of any geometry such that it may facilitate coupling of the pusher cap with the rod.

In other embodiments, the pusher cap may be a closed, funnel-shaped component with a flat top. In such embodiments, there may be an upper and a lower diameter, wherein the upper diameter may be larger than the lower diameter. The upper diameter may then be tapered downwards towards the lower diameter, creating a funnel-like shape with a flattened top. The flattened top may be the only portion of the pusher cap to provide direct pressure to the base of the ear of corn, for consistency of pressure. In still other embodiments, the pusher cap may be a completely flat cylinder with a lower extrusion that may aid in coupling the pusher cap to the rod. In one embodiment, such a lower extrusion may be of a cylindrical shape. In another embodiment, such a lower extrusion may be of a rectangular shape. In yet other embodiments, such a lower extrusion may be of any shape such that it may facilitate coupling of the pusher cap with the rod.

In other embodiments, the pusher cap may be a completely flat cylindrical component with no other extrusions of tapered components. In yet other embodiments, the pusher cap may be a completely flat rectangular component with no other extrusions of tapered components. In still other embodiments, the pusher cap may exist in any geometry, with any number of flat components, any number of tapered components, and any number of extrusions. Such flat components, tapered components, and extrusions may be of any shape, including circular, cylindrical, square, rectangular, and more. The pusher cap may or may not contain a flat portion which may apply consistent pressure on the base of the ear of corn. In embodiments wherein the pusher cap may not contain such a flattened portion, there may not be consistent pressure applied on the base as it is driven forward, which may lead to uneven cutting of kernels.

In some embodiments, the flattened portion of the pusher cap may be of a size approximately equivalent to the average size of a corn cob. This sizing may allow for adequate support and pressure to be placed on the ear of corn to bring it forward as the actuating device is initiated. In other embodiments, the flattened portion of the pusher cap may be of a size larger than the average size of a corn cob. This sizing may further allow for adequate support and pressure to be placed on the ear of corn to bring it forward as the actuating device is initiated. In yet other embodiments, the flattened portion of the pusher cap may be of a size smaller than the average size of a corn cob. This may not allow for as much support or pressure but may still adequately support the ear of corn as it is driven forward towards the blade. In still other embodiments, the flattened portion of the pusher cap may be of any size, such that it may provide adequate support and pressure to the base of the ear of corn to drive it towards the blade without necessitating excessive force from the user.

In embodiments wherein the pusher cap may not include a flattened portion, the sizing of the cap may be defined by the diameter of the curved or spherical portion that may apply pressure on the ear of corn. In one of these such embodiments, the diameter of the curved or spherical portion may be approximately equivalent to the average diameter of a corn cob. This sizing may allow for adequate support and pressure to be placed on the ear of corn to bring it forward as the actuating device is initiated. In another embodiment, the diameter of the curved or spherical portion may be larger than the average diameter of a corn cob. This sizing may further allow for adequate support and pressure to be placed on the ear of corn to bring it forward as the actuating device is initiated. In yet another embodiment, the diameter of the curved or spherical portion may be slightly smaller than the average diameter of a corn cob. This may not allow for as much support or pressure but may still adequately support the ear of corn as it is driven forward towards the blade. In still other embodiments, the curved or spherical portion of the pusher cap may be of any size, such that it may provide adequate support and pressure to the base of the ear of corn to drive it towards the blade without necessitating excessive force from the user.

When the actuating device is initiated, the rod may be moved forward towards the blade, as will be discussed in detail further below. Because the rod may be the only portion of the apparatus physically moving when the actuating device is initiated, the pusher cap may be coupled to the front of the rod such that it may also move forward as the rod is brought forward. In some embodiments wherein the pusher cap may contain lower portions or extrusions, as described above, such lower portions or extrusions may partially define a cavity, which may serve to secure the rod. Embodiments of pusher caps without lower portion or extrusions may also define a cavity. The cavity may be of any geometry but may be of a circular shape in some preferred embodiments. The cavity may be of a size approximately equivalent to the diameter or size of the rod, which may allow for secure coupling of the rod with the pusher cap without excessive constraint or room for movement. In one exemplary embodiments, the rod and corresponding cavity may be sized such that they may be directly and securely coupled together without the need for additional forms of attachment. In another embodiment, the rod and corresponding cavity may be coupled by means of glue or another adhesive.

In yet another embodiment, the cavity may be threaded, along with the end of the rod, to allow for easy coupling. Such threads may be of any size or profile such that they may easily fit with the threads of the rod. Because the pusher cap is making direct contact with the ear of corn, it may easily become contaminated by stray kernels or juices. Therefore, such a reversable attachment of the pusher cap to the rod, such as the aforementioned threaded approach, may be advantageous such that the pusher cap may be washed or cleaned independently of the rod and the rest of the apparatus. In still other embodiments, the cavity and corresponding pusher cap may be coupled with the rod through any means of attachment such that the attachment is secure. Reversible attachments may be particularly advantageous, for the reasoning provided above.

In other embodiments wherein the pusher cap may not contain a cavity, the lower portion or extrusion of the pusher cap may be directly coupled with the rod. In one of these such embodiments, the lower portion or extrusion of the pusher cap may be directly coupled with the rod by means of welding. In another embodiment, the lower portion or extrusion of the pusher cap may be directly coupled with the rod by means of glue or another adhesive. In yet another embodiment, the lower portion or extrusion of the pusher cap may be directly coupled with the rod by means of bolting or other forms of mechanical attachment. In still other embodiments, the lower portion or extrusion of the pusher cap may be directly coupled with the rod by means of any form of attachment such that the attachment is secure and may allow for the pusher cap to be driven forward with the rod.

In still other embodiments wherein the pusher cap may not contain a lower portion or extrusion, the pusher cap may be directly coupled with the rod. In one of these such embodiments, the pusher cap may be directly coupled with the rod by means of welding. In another embodiment, the pusher cap may be directly coupled with the rod by means of glue or another adhesive. In yet another embodiment, the pusher cap may be directly coupled with the rod by means of bolting or other forms of mechanical attachment. In still other embodiments, the pusher cap may be directly coupled with the rod by means of any form of attachment such that the attachment is secure and may allow for the pusher cap to be driven forward with the rod.

In one embodiment, the pusher cap may be constructed and formed of aluminum. In another embodiment, the pusher cap may be constructed and formed of stainless steel. In yet other embodiments, the pusher cap may be constructed and formed of any material such that the material is strong and firm enough to apply adequate pressure to the base of the ear of corn and drive it forward towards the blade.

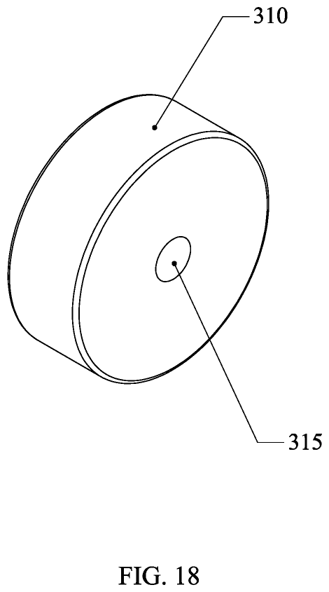

Turning now to FIG. 18, an isometric illustration of a pusher cap exemplary embodiment is shown. The pusher cap 310 may define a cavity 315, which may hold the front end of the central rod. Such a cavity may, in many embodiments, be of a diameter approximately equivalent to the diameter of the rod such that the rod may fit securely into the cavity, without excessive constraint or room for movement.

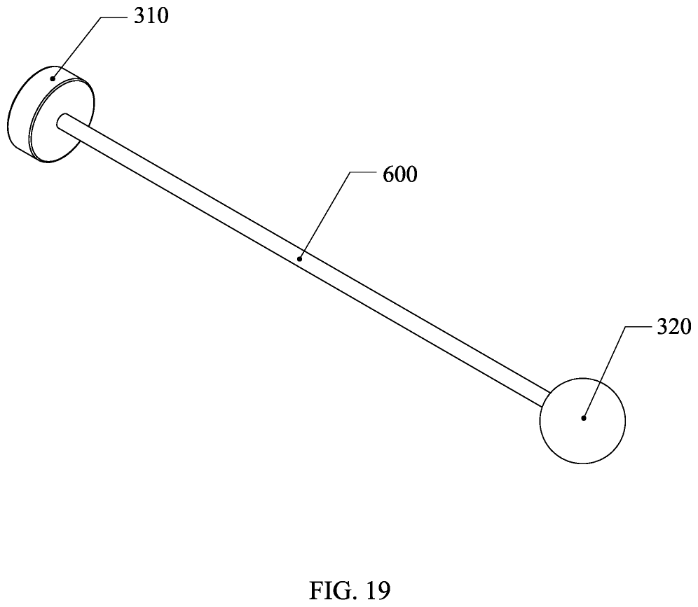

FIG. 19 shows an isometric illustration of a complete pusher device exemplary embodiment. As shown, a comfort grip 320 is placed at the end of the central rod 600. The central rod may fit into a cavity in the comfort grip, and any additional forms of attachment may be used to ensure a secure connection of the two components. A pusher cap 310 is placed at the opposing end of the central rod 600. The central rod may fit into a cavity defined in the pusher cap, and any additional forms of attachment may be used to ensure a secure connection.

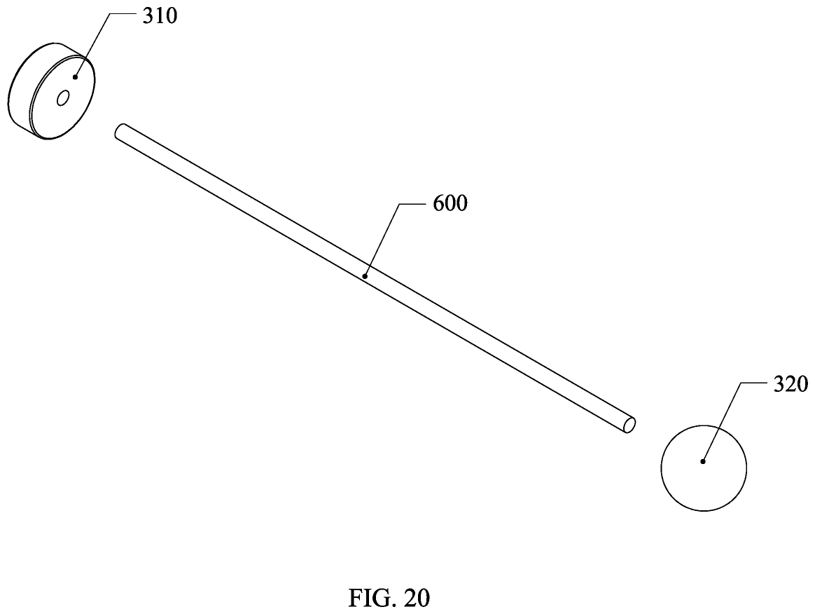

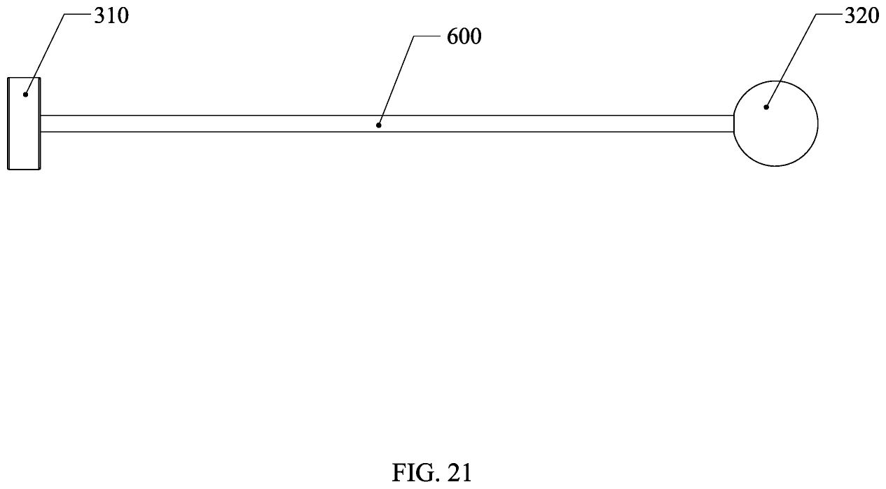

A more complete construction of pusher device exemplary embodiments is shown in FIG. 20 via an isometric exploded illustration of the apparatus. The coupling of pusher cap 310 and central rod 600 is shown via a cavity defined in the pusher cap. The coupling of the central rod 600 and comfort grip 320 is also clearly defined. FIG. 21 is a front view illustration of a pusher device exemplary embodiment, showing the pusher cap 310, central rod 600, and comfort grip 320.

The pusher device, as described above, may be the portion of the corn stripping apparatus that may directly drive the uncut portions of the ear of corn forward towards the blade. The pusher device may apply this continuous pressure through the use of a pusher cap located at the front of a rod. As the rod is moved forward, the pusher cap drives the ear of corn towards the blade. However, the rod must be moved forward by some manual or mechanical means. Therefore, exemplary embodiments of the corn stripping apparatus may further include a portion known henceforth as an actuating device. Such an actuating device may be a manual or automated device that may serve to continuously bring the rod, and corresponding pusher cap, forward, without relying on excessive force from the user.

Such an actuating device may exist in a variety of fashions. In one embodiment, for example, the actuating device may be automated and may consist simply of a power drill connected to the rod. In such an embodiment, the rod may contain a drill bit connector at its end, instead of the comfort grip discussed above. The user may then insert the drill bit portion into the power drill and run the drill to drive the rod forward. In this instance, the rod may be driven forward at an increased pace, as opposed to a manual initiation of the actuating device. Thus, the corn may be cut faster, and more ears of corn may be done in a smaller amount of time.

In another preferred embodiment, the actuating device may be a manual trigger mechanism wherein the user may pull a trigger, which may initiate the movement of a component known as a rod cam, which may use springs and other mechanisms to bring the rod forward and drive the pusher cap and ear of corn towards the blade. A detailed discussion of this trigger mechanism and its various components is below.

Preferred embodiments of this trigger mechanism actuating device may first include a frame wherein a number of components and mechanisms may be included. Such a frame may be of a simple or complex geometry. In some embodiments, such a frame may first consist of a flat, portion at the front of the component. Such a flattened component may serve to couple the frame and its corresponding components to the base ring and cob holder apparatus. In one embodiment, such a flattened portion may be circular. In another embodiment, such a flattened portion may be square. In yet other embodiments, such a flattened portion may be of any geometry such that it may facilitate proper attachment to the base ring through a variety of attachment methods.

In some embodiments, the aforementioned flattened portion may in fact not be flat. In one embodiment, for example, the portion may be tapered, with a larger diameter and a smaller diameter. In another embodiment, the portion may be rounded or spherical. In other embodiments, the portion may be of any geometry such that it may facilitate proper attachment to the base ring through a variety of attachment methods.

In many embodiments, the flattened, tapered, or spherical portion described above may define a cavity. Such a cavity may allow for the rod to pass through the frame and base ring and into the holder. Additionally, such a cavity may ease in coupling the frame to the base cap. In one embodiment, such a cavity may be circular. In another embodiment, such a cavity may be square. In yet other embodiments, such a cavity may be of any geometry such that it may allow for the passing of the rod through the cavity and aid in coupling the frame to the base cap. Because the rod must pass through the entire frame, the cavity may be deep enough to extend through the entire component.

In embodiments wherein a spanner nut is to be used to couple the frame to the base cap and holder apparatus, the aforementioned cavity may be of a diameter or size approximately equivalent to the diameter or size of the protrusion of the spanner nut. Such sizing may allow for secure attachment of the spanner nut to the frame, without excessive constraint or room for movement. Such a spanner nut and its use will be discussed in detail further below. In other embodiments wherein the base cap and frame are to be directly coupled by means of adhesives or other forms of attachment, the cavity may be of a diameter or size approximately equivalent to the diameter or size of the rod. This may allow for the rod to pass through the coupled frame and base cap without excessive constraint or room for movement.

Exemplary embodiments of a frame may further include a lower, vertical protrusion to be used as a grip as users initiate the actuating device. In one embodiment, such a vertical protrusion may be rectangular. In another embodiment, such a vertical protrusion may be cylindrical. In yet other embodiments, such a vertical protrusion may be of any geometry such that the user may easily hold onto the protrusion while initiating the trigger mechanism. In some embodiments, the vertical protrusion may include additional, smaller protrusions to aid in gripping the component. In one embodiment, for example, the vertical protrusion may contain a smaller, triangular extrusion to aid in the ergonomic handling of the component. In other embodiments, the vertical protrusion may contain any number of smaller extrusions that may be of any geometry or size. In some embodiments, the vertical protrusion may include ridges for aiding the user in gripping the component.

Exemplary embodiments of frames may further include a portion connecting the flattened, tapered, or spherical portion mentioned above to the aforementioned lower vertical protrusion. In one embodiment, such a portion may be rectangular. In another embodiment, such a portion may be triangular. In yet other embodiments, such a portion may be of any geometry such that the flattened, tapered, or spherical portion may be fully attached to the lower vertical protrusion. In many embodiments, such a connecting portion may define a small cavity located near the lower vertical protrusion or located at any point in the connecting portion. Such a small cavity may be used to secure the trigger component, and may hold trigger pins, as are discussed in detail further below. Thus, in many embodiments, the cavity may be of a diameter or size approximately equivalent to the diameter and size of the trigger pin. This sizing may allow for the trigger pin to fit securely into the cavity without excessive constraint or room for movement and may ensure the secure attachment of the trigger. In many embodiments, the cavity may be of the same shape as the trigger pin, in order to ensure secure attachment. In one embodiment, the cavity may be circular. In another embodiment, the cavity may be square. In yet other embodiments, the cavity may be of any geometry such that the trigger pin may be securely fit into the cavity without excessive constraint or room for movement.

Exemplary embodiments of frames may further include an empty inner portion wherein the components and mechanisms of the actuating device will be placed. In some embodiments, such an inner portion may be closed off by walls surrounding the inner portion. In one of these such embodiments, walls may be attached to the frame by means of welding. In another embodiment, walls may be attached to the frame by means of glue or another adhesive. In yet another embodiment, walls may be attached to the frame by bolting or other forms of mechanical attachment. In still other embodiment, walls may be attached to the frame by any form of attachment. In other embodiments, walls may not be included and the inner workings of the actuating device may not be hidden. The inner portion of the frame may contain a top portion that may serve to partially enclose the inner portion and hold various frame components together. In some embodiments, the top portion may consist of a simple rectangular frame, or a similar frame of any geometry. In other embodiments, the top portion may be fully covered by a component similar to the aforementioned walls. In one embodiment, such a component may be attached to the top frame by means of welding. In another embodiment, such a component may be attached to the top frame by means of glue or another adhesive. In yet another embodiment, such a component may be attached to the top frame by means of bolting or other forms of mechanical attachment. In still other embodiments, such a component may be attached to the top frame by means of any form of attachment.

The aforementioned inner portion of the frame may be partially enclosed by two flattened portions that may exist at opposing sides of the inner portion. In one embodiment, such flattened portions may be rectangular. In another embodiment, such flattened portions may be square. In yet other embodiments, such flattened portions may be of any geometry such that they provide an adequate shell to the frame and inner portion of the frame. Such flattened portions may be of any thickness. Increasing the thickness of the flattened portions may increase the sturdiness and support of the overall frame and actuating device. The front flattened portion may be located directly behind and attached to the above mentioned flattened, tapered, or spherical portion. The back flattened portion may be located at the far end of the frame and may define a cavity. Such a cavity may allow for the rod to pass through the frame. Thus, in many embodiments, such a cavity may be of a diameter or size approximately equivalent to the diameter or size of the rod, which may allow for secure attachment to the rod without excessive constraint or movement. In one embodiment, such a cavity may be circular. In another embodiment, such a cavity may be square. In yet other embodiments, such a cavity may be of any geometry such that it may fully support the rod passing through the frame.

In some embodiments, the frame may further include a horizontal protrusion extending from the top of the inner portion of the frame. Such a horizontal protrusion may serve to lock in place the thumb plate, which will be discussed in detail further below. Thus, the horizontal protrusion may be of a size and shape accommodating to the thumb plate. In one embodiment, such a horizontal protrusion may be T-shaped, with differing levels of depth in order to accommodate the shape of the thumb plate. In another embodiment, such a horizontal protrusion may be completely rectangular with a small inner portion carved out to support the thumb plate. In yet other embodiments, such a horizontal protrusion may be of any geometry that may fully support the thumb plate and lock the component into place.

In one embodiment, the described frame of the actuating device may be constructed and formed of aluminum. In another embodiment, the frame of the actuating device may be constructed and formed of stainless steel. In yet another embodiment, the frame of the actuating device may be constructed and formed of hardened plastic. In still other embodiments, the frame of the actuating device may be constructed and formed of any material such that the frame is solid and able to fully support the remainder of the actuating device, and strong enough to allow user engagement with the frame.

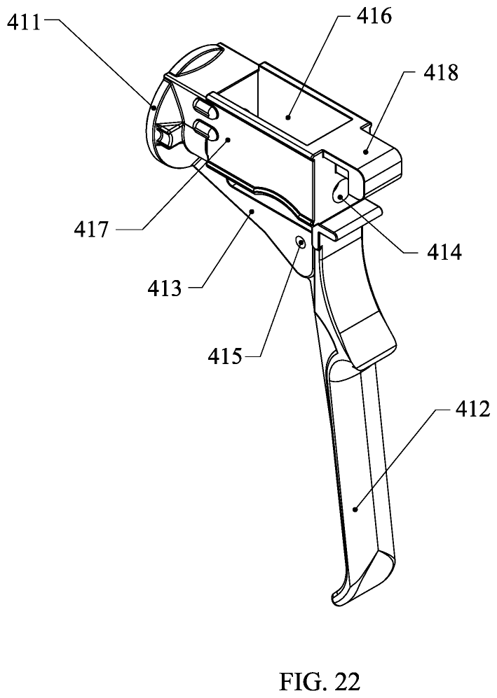

Turning now to FIG. 22, an isometric illustration of an actuating device frame exemplary embodiment is shown. As described, a flattened portion 411 is located at the front of the frame and is used to facilitate connection with the cob holder and additional components. In some embodiments, this front face 411 may not be flat, and instead may be spherical, rounded, or of any geometry. This front face 411 may be circular, square, or of any geometry. The frame may further consist of a lower extrusion 412 acting as a handle. This handle 412 may contain any number of grips, extrusions, or other features such that it may allow the user to handle the actuating device frame. The frame may further contain a connecter portion 413 that may serve to link the front face 411 to the handle 412. Such a connector portion 413 may be triangular, rounded, or of any geometry. The connector portion may include a trigger pin cavity 415, which may allow for trigger pins to be used to secure the trigger to the frame. Such a trigger pin cavity 415 may be of a diameter approximately equivalent to the diameter of the corresponding trigger pin such that the trigger pin may fit securely into the cavity without excessive constraint or room for movement.

The frame may further consist of an inner portion 416 wherein the inner mechanics and other components of the actuating device may be included. In some embodiments, the inner portion 416 may be closed off by walls 417 such that the inner mechanics of the actuating device may not be visible. The top of the inner portion 416 may contain an upper extrusion 418 that may be used to secure the thumb plate or other components. Such an upper extrusion 418 may be of a T-shape, rectangular, or of any geometry such that it may adequately hold and secure the thumb plate or other component. The frame may finally contain a rod cavity 414 that may hold the central rod as it is brought forward by initiation of the locking device. Such a rod cavity 414 may be of a diameter approximately equivalent to the diameter of the central rod such that the rod may securely fit into the cavity without excessive constraint or room for movement.

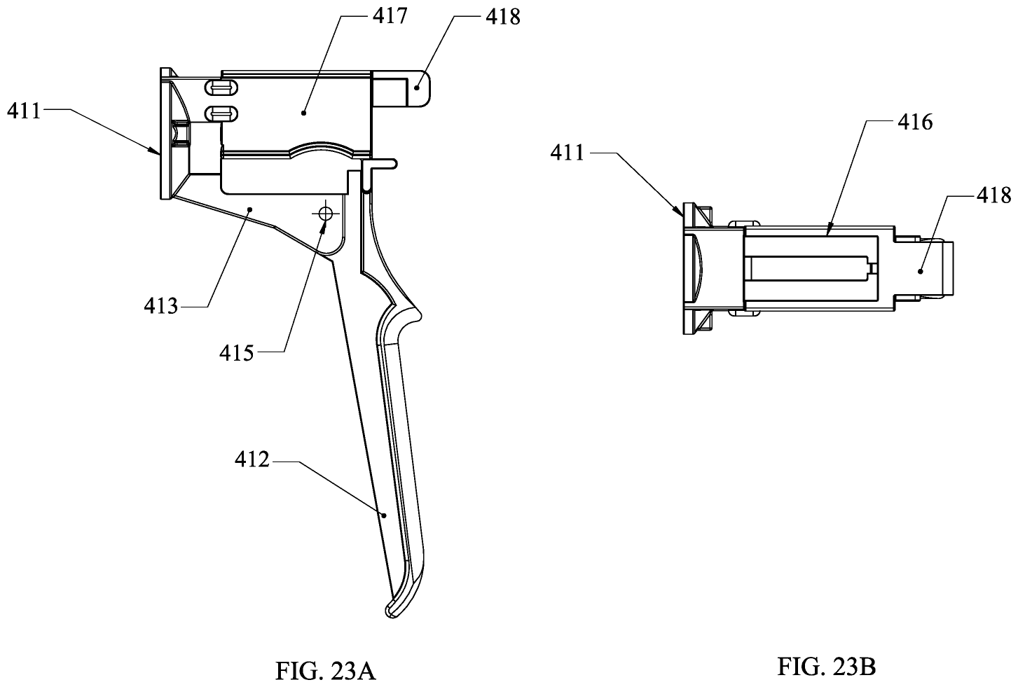

FIG. 23A is a front view illustration of an actuating device frame exemplary embodiment. As shown, the front face portion 411 is located at the front of the frame, and a connector portion 413 containing a trigger pin cavity 415 is used to connect the front face 411 to the handle 412. The front wall 417 of the frame's inner portion is shown and may close off the portion of the frame containing the inner mechanisms and other components of the actuating device. This front wall 417 may not be included in some embodiments. Further, the frame's upper extrusion 418 which may hold the thumb plate or other components is shown. FIG. 23B is a top view illustration of an actuating device frame exemplary embodiment. The front face 411 is shown, as well as the inner portion 416 containing additional components, and the upper extrusion 418.

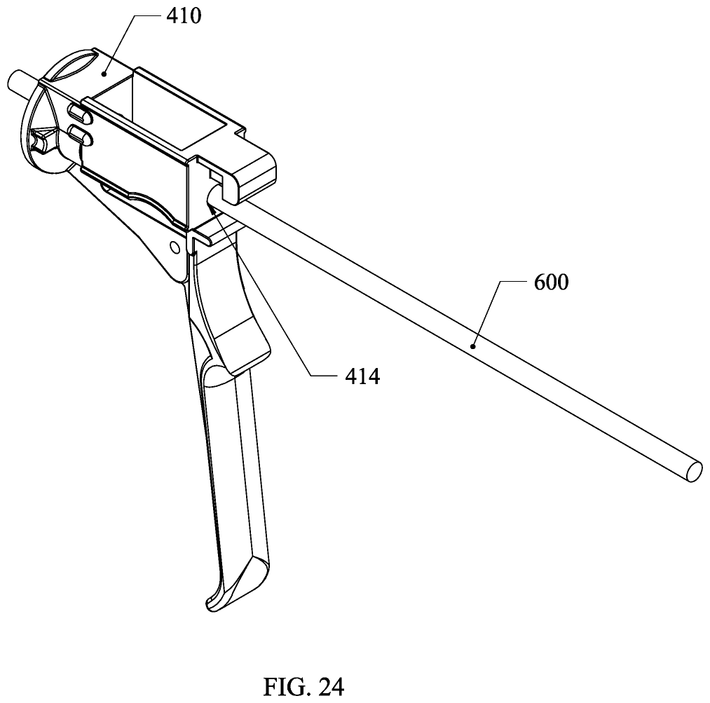

FIG. 24 is an isometric illustration of an actuating device frame exemplary embodiment coupled with a central rod exemplary embodiment. As shown, the central rod 600 is fit through a rod cavity 414 at the back end of the frame 410.

The actuating device may further contain a hollow vertical portion known as a trigger. Such a trigger may be attached to the frame and may fit around the lower vertical protrusion of the frame. In one embodiment, the trigger may be fully open on one side and closed on the other side of the component. In another embodiment, the trigger may be fully closed on both sides of the component. In yet another embodiment, the trigger may be fully open on one side and closed on the other side, containing ridges on the closed side to aid in user grip. In still other embodiments, the trigger may be of any geometry, with any number of ridges, protrusions, or other features, such that it may fully fit into the frame and may be adequately pulled by the user to initiate the actuating device.

In many embodiments, the trigger may at least include two flat front and back portions that may define a shell. In one embodiment, such flat front and back portions may be of a rectangular shape. In another embodiment, such flat front and back portions may be of a triangular shape. In yet other embodiments, such flat front and back portions may be of any geometry such that they may allow the trigger to fit fully into the frame. The flattened front and back portions may define cavities to be used as trigger pin holes. In one embodiment, the trigger may contain one cavity. In another preferred embodiment, the trigger may contain two cavities. In yet other embodiments, the trigger may contain any number of cavities. Such cavities may hold trigger pins, which may aid in the mechanism of the actuating device.

In many embodiments, such cavities may be of a diameter or size approximately equivalent to the diameter or size of the trigger pin. Such sizing may ensure trigger pins are fully supported in their cavities, without excessive constraint or room for movement. In one embodiment, such cavities may be circular in shape. In another embodiment, such cavities may be rectangular in shape. In yet other embodiments, such cavities may be of any geometry such that the trigger pins may fit fully and securely into the cavities, without excessive constraint or room for movement. It may be advantageous, however, to construct the cavities in the same or similar shape as the trigger pins, which may aid in ensuring a fully supported fit. Because the trigger pin must pass through cavities in both aforementioned front and back portions, in many embodiments, the width of the trigger, or the width of the space between the front and back portions, may be approximately equivalent to the length of the trigger pin. This may allow for the trigger pin to be fully supported by the front and back portions without excess portions of the trigger pin extruding from the cavities, which may pose a safety hazard or increase difficulty of use. In some embodiments, the aforementioned cavities may be threaded, along with the trigger pins, for ease of insertion and coupling of the trigger pins with their corresponding cavities. Threads may be of any size and profile such that they may fit easily with threads located on the trigger pin.

In one embodiment, the trigger may be constructed and formed of aluminum. In another embodiment, the trigger may be constructed and formed of stainless steel. In yet another embodiment, the trigger may be constructed and formed of hardened plastic. In still other embodiments, the trigger may be constructed and formed of any material such that the trigger is solid and able to fully withhold the pulling and other engagement with the trigger from the user.

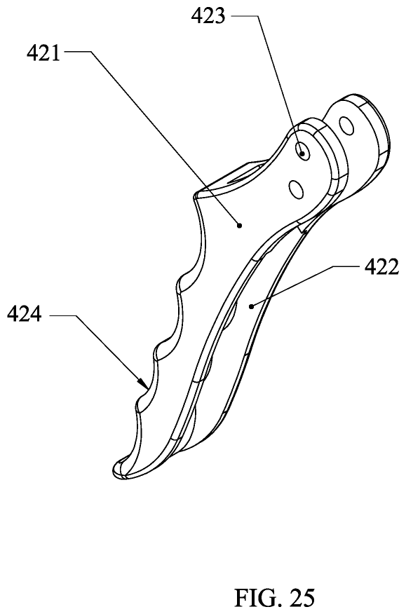

Turning now to FIG. 25, an isometric illustration of a trigger exemplary embodiment is shown. As described, the trigger may consist of a shell defined by a flat front face 421 and a flat back face 422. In some embodiments, the trigger may define ridges 424 for grip, allowing the user to more easily hold onto the component. The trigger may further define trigger pin cavities 423 to hold trigger pins that may connect the trigger to the frame or aid in the actuating device mechanism. Such trigger pin cavities 423 may be of a diameter approximately equivalent to the diameter of the corresponding trigger pin, such that the pin fits securely into the cavity without excessive constraint or room for movement.

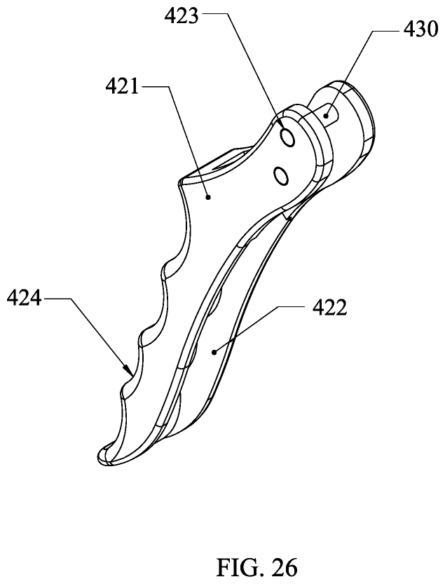

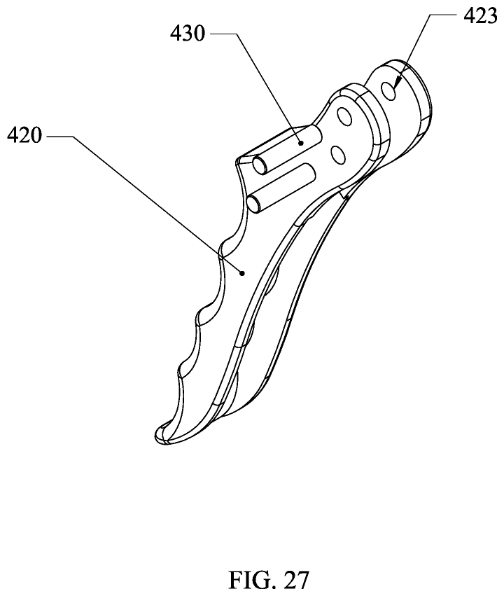

FIG. 26 shows an isometric illustration of a trigger exemplary embodiment with trigger pins included. As shown, the trigger pins 430 are inserted into the trigger pin cavities 423 located in front face 421 and back face 422. The ridges 424 on the trigger are also shown. The coupling of the trigger pins and trigger are further shown in FIG. 27 via an isometric exploded view of the two components. The insertion of the trigger pins 430 into the trigger pin cavities 423 located in the trigger 420 is shown.

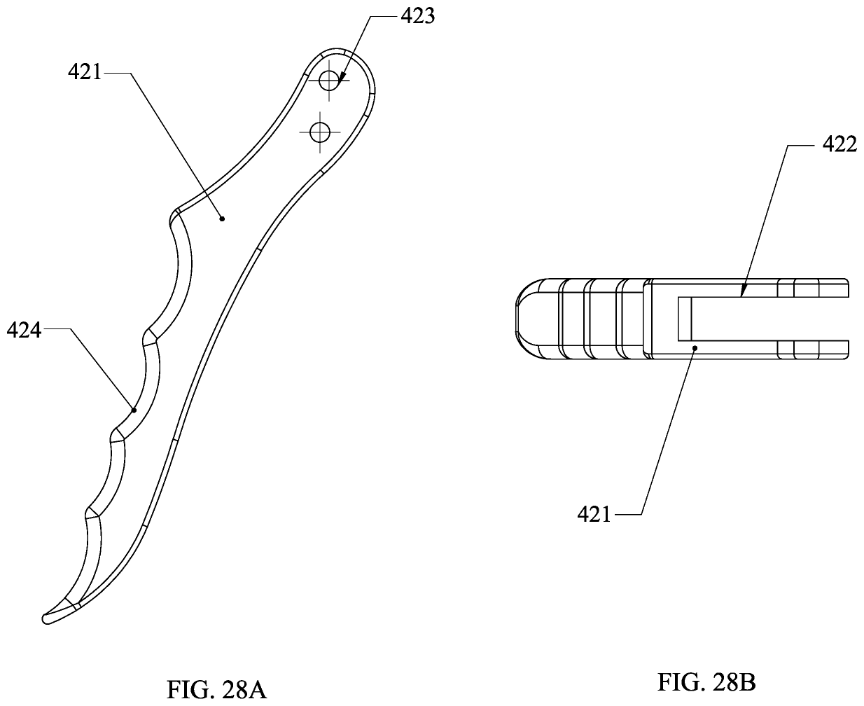

FIG. 28A is a front view illustration of a trigger exemplary embodiment without trigger pins. The front face 421 defines trigger pin cavities 423 to hold trigger pins. The ridges 424 on the trigger are also shown. FIG. 28B is a top view illustration of a trigger exemplary embodiment wherein the shell-like geometry of the component is more clearly shown. The front face 421 is shown, as well as the back face 422. The distance between the two faces may, in many embodiments, be approximately equivalent to the width of the actuating device frame such that it may easily fit around the frame and may also be approximately equivalent to the length of the trigger pin such that the pins may fit fully and securely into the trigger pin cavities between the faces without any excess.

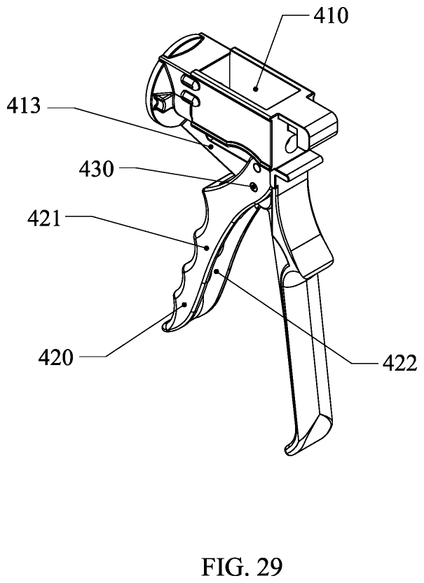

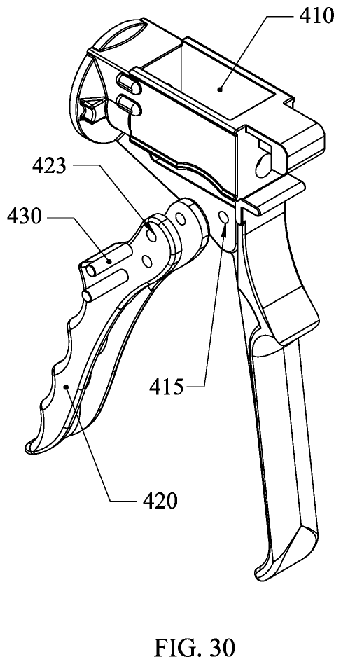

FIG. 29 is an isometric illustration of a trigger exemplary embodiment coupled with an actuating device frame exemplary embodiment by means of trigger pins. As shown, the trigger pins 430 fit into trigger pin cavities defined in both the trigger 420 and frame 410. The trigger's shell further fits around the frame such that the front face 421 is placed in front of the frame's connector portion 413, and the back face 422 is placed behind the connector portion 413. The coupling of the frame and trigger with trigger pins is further shown in FIG. 30 via an isometric exploded view of the components. As shown, trigger pins 430 fit into trigger pin cavities 423 defined in the trigger 420. One or more trigger pins 430 may further fit into trigger pin cavities 415 defined in the frame 410. Thus, at least one trigger pin is fit through cavities in both components and couple the frame and trigger together. In some embodiments, additional forms of attachment may be used to secure the connection between the two components.

The actuating device may further consist of at least one trigger pins, as mentioned above. In one preferred embodiment, the actuating device may consist of two trigger pins. In another embodiment, the actuating device may consist of one trigger pin. In yet other embodiments, the actuating device may consist of more than two trigger pins. The trigger pins may be located in previously mentioned trigger pin cavities. In many embodiments, such trigger pin cavities may be located on the trigger itself. In some embodiments, there may be additional trigger pin cavities located on the frame of the actuating device.

In many embodiments, at least one trigger pin may pass through cavities in the trigger, but not the frame. In such embodiments, such a trigger pin may rest directly above the frame and may be a driving mechanism for the actuating device. When the trigger is pulled, the trigger pin may move forward, applying pressure on other components, such as the rod cam, to bring the rod forward. In embodiments wherein there may be two trigger pins, the second trigger pin may pass through cavities in both the trigger and the frame of the actuating device. Such a trigger pin may serve the primary purpose of coupling the trigger to the frame and the rest of the actuating device.

In one embodiment, trigger pins may be smooth, cylindrical components. In another embodiment, trigger pins may be rectangular. In yet other embodiments, trigger pins may be of any geometry such that they may fit into the aforementioned trigger pin cavities. In many embodiments, trigger pins may be of a diameter or size approximately equivalent to the diameter or size of the corresponding trigger pin cavities, which may allow for easy securing of trigger pins within the cavities without excessive constraint or room for movement. In some embodiments, trigger pins may contain a flattened portion at the end of the body, which may have a larger diameter. In such embodiments, such a larger, flattened portion may serve as a barrier holding the trigger pin in the cavity and may prevent excessive movement of the pin. In other embodiments, trigger pins may contain any cavities or extrusions such that secure attachment of the trigger pins with the trigger is ensured.

In some embodiments, trigger pins and their corresponding trigger pin cavities may be of a size such that no additional attachments are necessary to secure the trigger pin in its cavity. In other embodiments, glue or other adhesives may be used to ensure that the trigger pin is securely placed in the trigger pin cavities. In yet other embodiments, the body of the trigger pin may be at least partially threaded, along with the trigger pin cavity, for ease of insertion and coupling of the trigger pins with their corresponding cavities. Threads may be of any size and profile such that they may fit easily with threads located in the trigger pin cavity. In still other embodiments, any method of attachment may be used to aid in the secure coupling of trigger pins with their corresponding trigger pin cavities.

In one embodiment, trigger pins may be constructed and formed of aluminum. In another embodiment, trigger pins may be constructed and formed of stainless steel. In yet other embodiments, trigger pins may be constructed and formed of any material such that the material is firm and solid enough to couple the trigger to the frame, and to push other components of the actuating device forward when the trigger is pulled. In many embodiments, the trigger pin may be of a length approximately equivalent to the width of the trigger, which may allow the trigger pin to fully fit within the trigger's cavities without any excess.

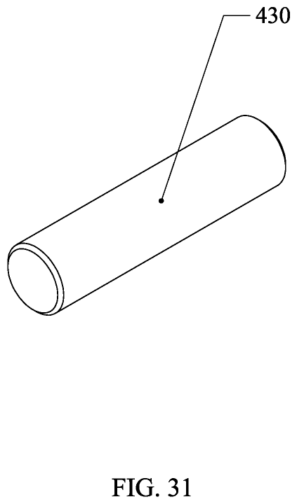

Turning now to FIG. 31, an isometric illustration of a trigger pin exemplary embodiment is shown. The trigger pin 431 may exist in this geometry as a simple cylindrical component, or in any geometry such that it may securely fit into trigger pin cavities defined in the trigger and actuating device frame. The trigger pin 431 may be of a diameter approximately equivalent to the diameter of the corresponding trigger pin cavities such that it may fit securely into the cavities without excessive constraint or room for movement.

The actuating device may further be consisted of a rod cam component, which may be located in the inner portion of the frame. In some embodiments, the rod cam may be securely attached to the apparatus' central rod such that it may bring the rod forward when the rod cam is brought forward. The rod cam may contain a portion directly resting against at least one of the trigger pins. Such a trigger pin may not serve the purpose of coupling the trigger pin to the frame and may simply exist in aiding the actuating device's mechanism. When the trigger is pulled, the trigger pin may move forward and apply pressure on the rod cam, which may in turn move forward. Due to the aforementioned secure attachment of the rod cam to the rod, the rod may be brought forward along with the trigger pin and rod cam.

In some embodiments, there may be a compression spring located directly in front of the rod cam that may allow the component to return to its initial position when the trigger is released. Such a spring may contain diameters or sizes approximately equivalent to or slightly larger than the diameter or size of the rod, such that it may securely fit onto the rod. In one embodiment, the compression spring may be constructed and formed of aluminum. In another embodiment, the compression spring may be constructed and formed of stainless steel. In yet other embodiments, the compression spring may be constructed and formed of any material such that the spring may successfully return the rod cam to its initial position. In some embodiments, the compression spring may be directly coupled to the rod cam to ensure a secure connection. In one of these such embodiments, for example, the compression spring may be attached to the rod cam through use of glue or another adhesive. In another one of these such embodiments, the compression spring may be attached to the rod cam via welding. In yet other embodiments, the compression spring may be attached to the rod cam via any form of attachment such that the mechanisms of both components are not compromised. In other embodiments, there may not be any additional forms of attachment between the compression spring and the rod cam, and mechanisms may rely on the proximity of the two components.

In some embodiments, the rod cam may consist of at least two parts, including an upper portion that may be contained around the apparatus' central rod, and a lower portion that may rest directly in front of the trigger pin. In one embodiment, for example, the rod cam may be of a T-shape, with an upper rectangular portion that may support the rod and a lower rectangular portion that may rest in front of the trigger pin. In such an embodiment, the upper portion may define a cavity such that the rod may be inserted into the rod cam and directly coupled with the component. In one embodiment, such a cavity may be of a circular shape. In another embodiment, such a cavity may be of a rectangular shape. In yet other embodiments, such a cavity may be of any geometry such that it may secure the rod. In many embodiments, such a cavity may be of a geometry identical or similar to the geometry of the rod such that a more secure connection between the two components is ensured. In many embodiments, such a cavity may be of a diameter or size approximately equivalent to the diameter or size of the rod. This may allow for the rod to fit fully and securely into the rod cam's cavity without excessive constraint or room for movement. The lower rectangular portion in this embodiment may rest directly in front of the trigger pin such that any pressure from the trigger pin may be transferred to the rod cam and drive the component forward. In some embodiments, additional attachments such as glue or other adhesives may exist between the trigger pin and lower portion of the rod cam such that attachment is secure and pressure may easily be transferred. In other embodiments, the attachment and transfer of pressure between the trigger pin and rod cam may rely on proximity of the two components.

In another embodiment, the rod cam may consist of a rounded upper portion and a rectangular lower portion. In such embodiments, the rounded upper portion may define a cavity for holding and securing the rod. The geometry and sizing of such a cavity may be identical or similar to the geometry and sizing of the rod, as described above, to ensure secure attachment of the rod to the rod cam. The lower rectangular portion in this embodiment may rest against the trigger pin such that any pressure from the trigger pin may be transferred to the rod cam and drive the component forward. As mentioned above, additional attachment methods may be included to aid in securing the trigger pin to the rod cam, or the mechanism may rely on proximity of the two components. In other embodiments, the rod cam may be of any geometry such that there may be an upper portion containing a cavity that will secure the rod, and a lower portion that may rest in front of the trigger pin and move forward following application of pressure from the pin.

In yet other embodiments, the rod cam may not consist of two portions, and may instead consist of one portion. In one of these embodiments, for example, the rod cam may be a simple rectangular component that may contain a cavity at the center or near the top. Such a cavity may, as described above, hold and secure the rod. Such a cavity may be of a size and geometry identical or similar to the size and geometry of the rod in order to ensure a fully secure connection, as described above. The bottom of the rectangular component in this embodiment may rest directly in front of the trigger pin such that the trigger pin may transfer pressure to the rod cam and drive the component forward. In still other embodiments, the rod cam may be of any geometry such that it contains a cavity or another way to secure the rod, and it may rest in front of the trigger pin such that the trigger pin may apply pressure to the rod cam.

In one embodiment, the rod cam may be constructed and formed of aluminum. In another embodiment, the rod cam may be constructed and formed of stainless steel. In yet other embodiments, the rod cam may be constructed and formed of any material such that it is firm enough to bring the rod forward and successfully aid in operating the actuating device mechanism.

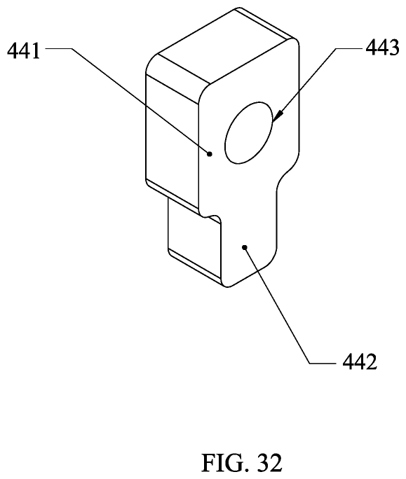

Turning now to FIG. 32, an isometric illustration of a rod cam exemplary embodiment is shown. As described, the rod cam may be consisted of two components, including an upper portion 441 and a lower portion 442. The upper portion may contain a rod cavity 443 for fitting the central rod through the component. Such a rod cavity 443 may be of a diameter approximately equivalent to the diameter of the central rod such that the rod may fit securely into the cavity without excessive constraint or room for movement. In some embodiments, the rod cam may be T-shaped. In other embodiments, the rod cam may be of any geometry such pressure may be applied on the component to move it forward with the rod.

FIG. 23 is an isometric illustration showing the placement of a rod cam exemplary embodiment on the apparatus' central rod. The central rod 600 is fed through the rod cavity 443 defined in the rod cam 440. A compression spring 450 may be located directly in front of the rod cam and may aid in pushing the rod forward when pressure is applied to the rod cam. Such a compression spring may be of a diameter or size approximately equivalent to the diameter or size of the central rod such that it may fit securely on the rod.

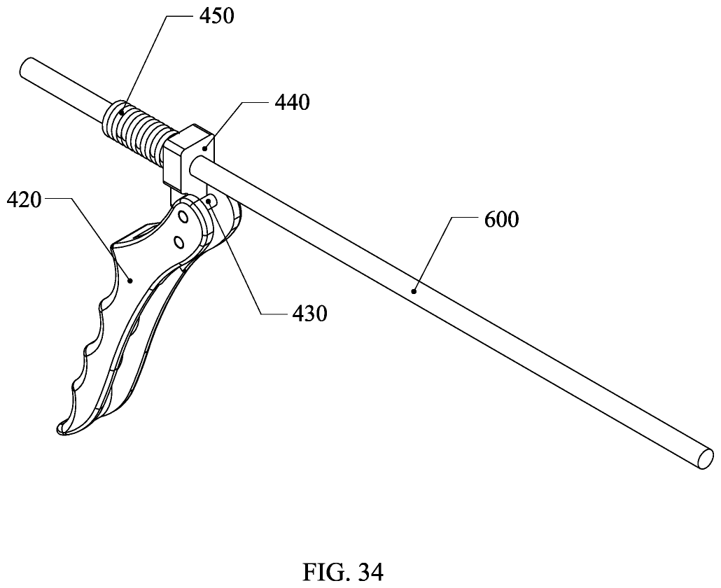

FIG. 34 shows an isometric illustration of the rod cam and compression spring mounted upon the central rod, as well as the placement of the trigger in regard to the rod cam. As shown, the central rod 600 fits through a rod cavity in the rod cam 440 and through the compression spring 450. The trigger 420 is located directly below the rod cam 440 such that the exposed trigger pin 430 may make direct contact with the lower portion of the rod cam. This may allow for the transfer of pressure from the trigger pin to the rod cam when the trigger is pulled, allowing the rod cam to move forward with the rod.

The actuating device may further include a portion that may serve to couple the front end of the frame to the back end of the base cap such that the actuating device may be securely attached to the cob holder apparatus. In one embodiment, this attachment may be facilitated through the use of a spanner nut component. Such a spanner nut may be located between the front end of the frame and the back end of the base cap. In some embodiments, a rubber washer may be located between the spanner nut and frame such that any abrasion or damage of the frame or spanner nut resulting from the connection is avoided. In other embodiments, the rubber washer may not be included.

In many embodiments, the spanner nut may consist of at least two components, including a base and an extrusion. The base portion may be directly coupled to the front face of the frame. In one embodiment, the base may be coupled to the frame by means of welding. In another embodiment, the base may be coupled to the frame by means of glue or another adhesive. In yet another embodiment, the base may be coupled to the frame by bolting or other forms of mechanical attachment. In still other embodiments, the base may be coupled to the frame by any form of attachment such that the attachment is secure and does not interfere with the actuating device's mechanism. In order to ensure a secure connection between the two components, it may be advantageous to construct the base in a geometry identical or similar to the identical of the front portion of the frame. In one embodiment, the base may be a flat, circular component. In another embodiment, the base may be a tapered, circular component. In yet another embodiment, the base may be of a flat, rectangular component. In still other embodiments, the base may be of any geometry such that it may securely attach to the frame and fully support the remainder of the spanner nut. In many embodiments, the base may be of a diameter or size approximately equivalent to the front end of the frame, which may allow for a secure connection avoiding excessive constraint or room for movement. The circular base may further contain any number of cavities, partial cavities, extrusions, or other features around the bottom or top of the base, such that the spanner nut may still attach the base cap and frame.

The spanner nut may further contain an extruded portion that may be directly coupled with the base cap, through the insertion of the extruded portion into the base cap's cavity. In some embodiment, additional attachment methods such as glue or other adhesives may aid in securing this attachment. It may be advantageous to construct the extruded portion in a geometry identical or similar to the geometry of the base cap's cavity. In one embodiment, the extrusion may be of a cylindrical geometry. In another embodiment, the extrusion may be of a rectangular geometry. In yet other embodiments, the extrusion may be of any geometry such that it may securely fit into the base cap's cavity. The protrusion may further define a cavity, which may serve the purpose of holding the apparatus' central rod. In one embodiment, such a cavity may be of a circular shape. In another embodiment, such a cavity may be of a square shape. In yet other embodiments, such a cavity may be of any geometry such that it may fully support the rod. In some embodiments, the cavity may be of a diameter or size approximately equivalent to the diameter or size of the rod. Such sizing may allow for the rod to fit securely into the cavity without excessive constraint or room for movement. In other embodiments, the cavity may be of a diameter or size slightly larger than the diameter or size of the rod. Such sizing may allow for the rod to fit securely into the cavity without excessive constraint but may allow for the rod to move forward through the cavity.

In one embodiment, the spanner nut may be constructed and formed of aluminum. In another embodiment, the spanner nut may be constructed and formed of stainless steel. In yet other embodiments, the spanner nut may be constructed and formed of any material such that the material is strong enough to fully couple the base cap and corresponding cob holder apparatus to the frame and corresponding actuating device. In some embodiments, a spanner nut may not be used, and other forms of attachment may be used to couple the two components. In one of these such embodiments, for example, the base cap and frame may be coupled by means of bolting or other forms of mechanical attachment. In another embodiment, the base cap and frame may be coupled by means of glue or another adhesive. In yet other embodiments, the base cap and frame may be coupled by any attachment methods such that the attachment is secure and interference with the mechanisms of the actuating device is avoided.

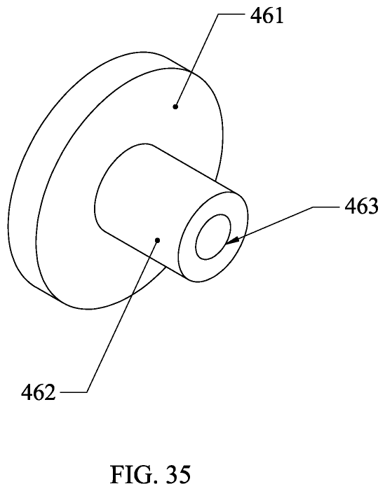

Turning now to FIG. 35, an isometric illustration of a spanner nut exemplary embodiment is shown. As described, the spanner nut may be consisted of two components, including a base component 461 and an extruded portion 462. The base component 461 may be flat, tapered, circular, or of any geometry such that it may adequately connect the base cap with the actuating device frame. The extruded portion 462 may further be cylindrical or of any geometry such that it may securely fit into the cavity in the front face portion of the actuating device frame. The extruded portion 462 may be of a diameter or size approximately equivalent to the diameter or size of the cavity in the front face portion of the frame such that it may securely fit into the cavity without excessive constraint or room for movement. The extruded portion may further define a cavity 463 that may hold the central rod as it passes through the spanner nut. The rod cavity 463 may be of a diameter approximately equivalent to the diameter of the rod such that the rod may securely fit into the cavity without excessive constraint or room for movement.

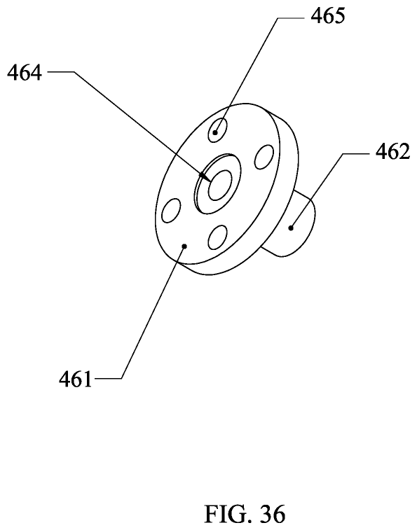

FIG. 36 shows a secondary view of a spanner nut exemplary embodiment, showing the left side of the component. The base portion 461 may define a number of partial cavities 465 or other features to ensure secure coupling of the base portion to the base cap. The base portion 461 may further define a rod cavity 464 for the central rod to pass through. Similar to the rod cavity in the extruded portion 462, the cavity 464 may be of a diameter approximately equivalent to the diameter of the central rod such that the central rod may securely fit into the cavity without excessive constraint or room for movement.

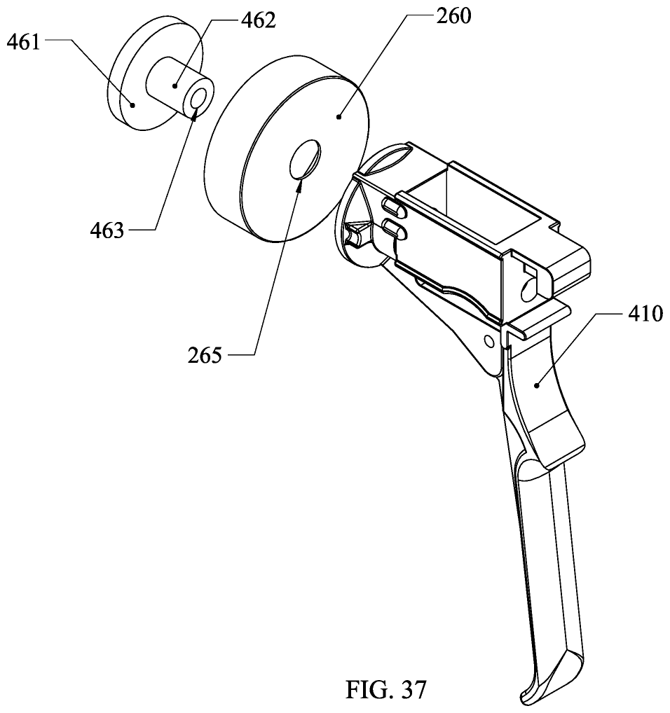

FIG. 37 is an isometric exploded illustration of the coupling of a spanner nut exemplary embodiment with a base cap and actuating device frame. As shown, the spanner nut is located in front of both components. The extruded portion 462 may be inserted into a cavity 265 defined in the base cap 260, as well as a similar cavity defined in the frame 410. The rod may then pass through the cavities in the three components and the rod cavity 463 in the spanner nut. In some embodiments, additional forms of attachment may be used to ensure secure coupling of the components.

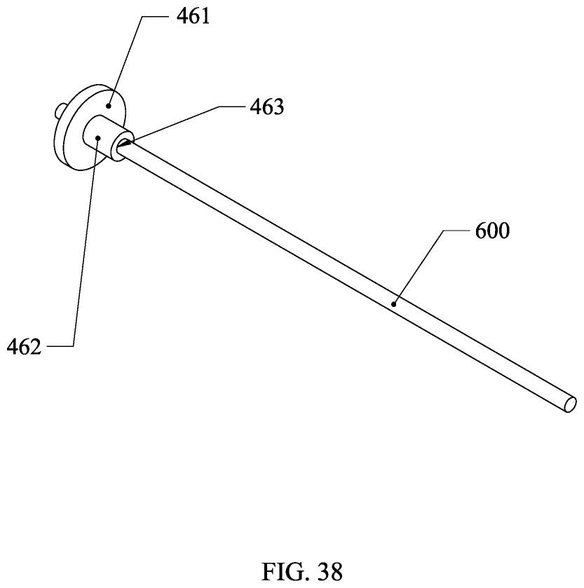

FIG. 38 is an isometric illustration showing the attachment of a spanner nut exemplary embodiment to a central rod. As shown, the central rod 600 passes through a rod cavity 463 in the spanner nut's extruded portion 462, as well as through a second rod cavity located in the spanner nut's base portion 461. In some embodiments, additional forms of attachment may be used to ensure secure coupling of the components.

In some embodiments, the actuating device may not consist of a trigger mechanism and may consist of a different mechanism for pushing the rod forward, either by automated or manual means.

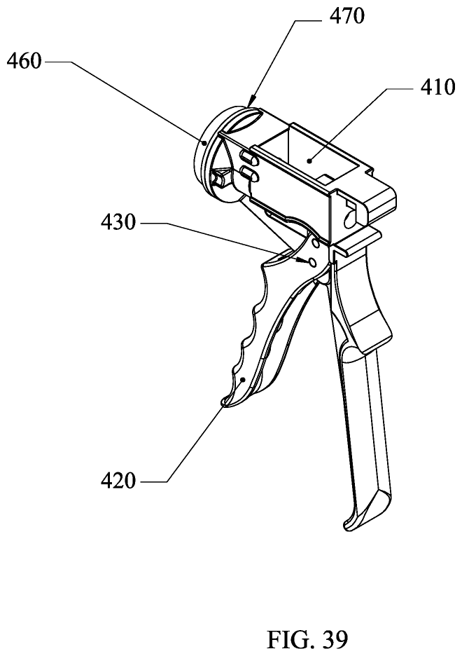

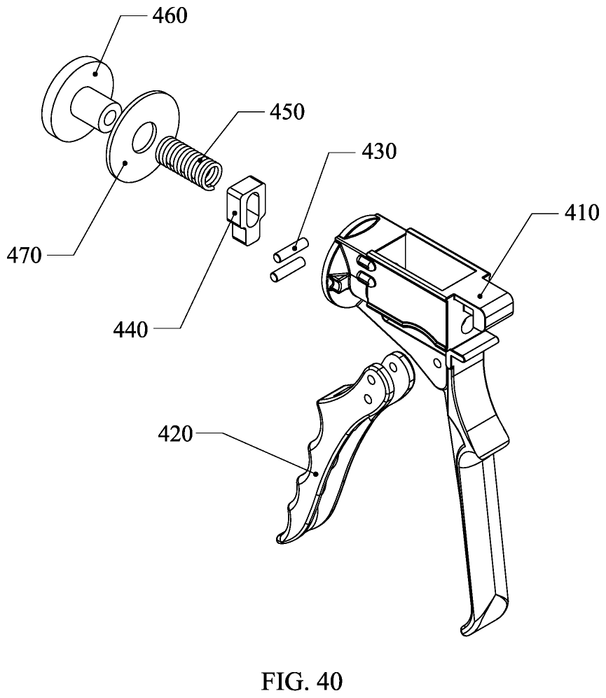

Turning now to FIG. 39, an isometric illustration of a complete actuating device exemplary embodiment is shown. As described, the trigger 420 fits into the frame 410 via trigger pins 430 and trigger pin cavities. In some embodiments, a rubber washer 470 may be included in between the frame 410 and spanner nut 460 to prevent the device from damage. The construction of the actuating device exemplary embodiment is further shown in FIG. 40 via an isometric exploded illustration. As shown, the spanner nut 460 first connects with a rubber washer 470, which may be in direct contact with the frame 410. The interior mechanisms may contain a compression spring 450 located directly in front of a rod cam 440. The trigger 420 may further fit into its location in the frame via trigger pins 430.

In some embodiments, the rubber washer 470 is a compression limiting washer for the spanner nut. It allows the spanner nut that fastens the cob holder to the actuating device frame to be tightened while still allowing the cob holder to rotate. The ability to rotate the cob holder facilitates for right or left hand use of the kernel cutter.

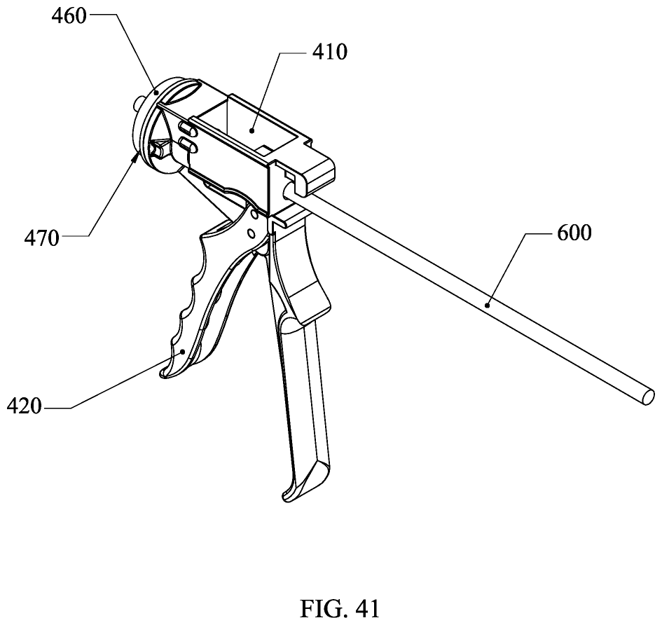

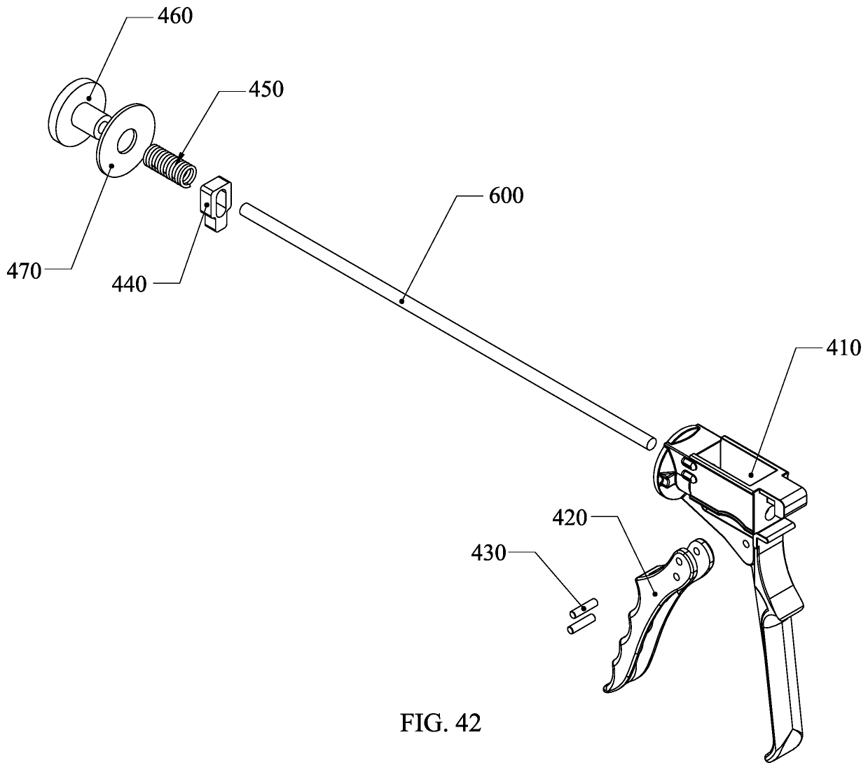

FIG. 41 is an isometric illustration of a complete actuating device exemplary embodiment with the central rod included. As shown, the central rod 600 passes through cavities in the frame 410, rubber washer 470, and spanner nut 460 to remerge on the opposite side of the spanner nut to be coupled with the pusher cap. The construction of the actuating device exemplary embodiment is further shown in FIG. 42 via an isometric exploded illustration. The trigger 420 is connected to the frame 410 via trigger pins 430, and the rod 600 passes through cavities in the frame. The rod 600 also passes through a cavity in the rod cam 440 and the compression spring 450, allowing the rod cam and compression spring to be located in the inner portion of the frame. The rod then passes through cavities in the rubber washer 470 and spanner nut 460.

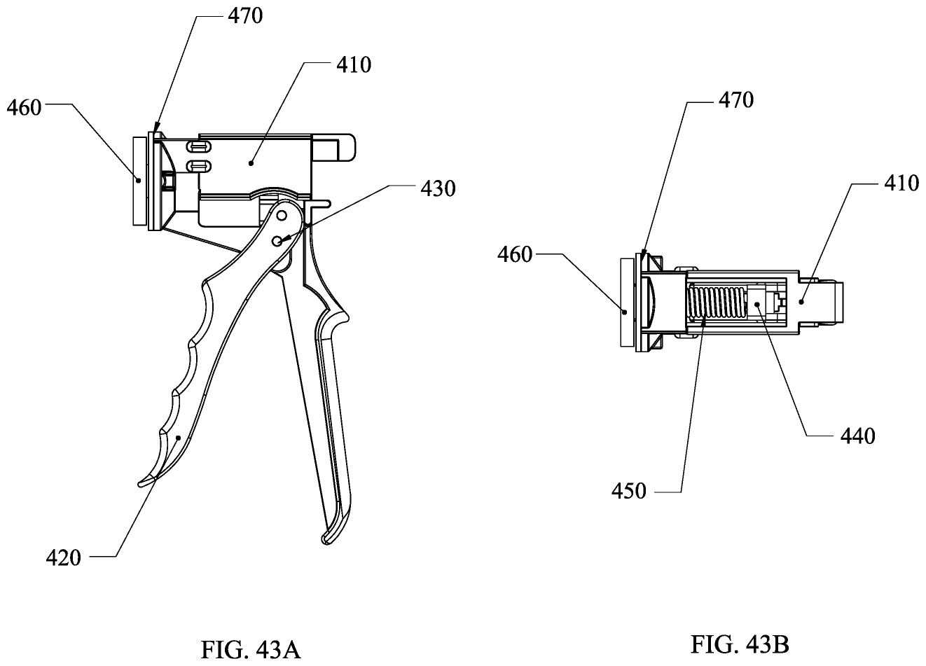

FIG. 43A is a front view illustration of a complete actuating device exemplary embodiment, wherein the frame 410, trigger 420, trigger pins 430, rubber washer 470, and spanner nut 460 are shown. FIG. 43B is a top view illustration of a complete actuating device exemplary embodiment, wherein the rod cam 440 and compression spring 450 are shown within the inner portion of the frame 410, as well as the spanner nut 460.

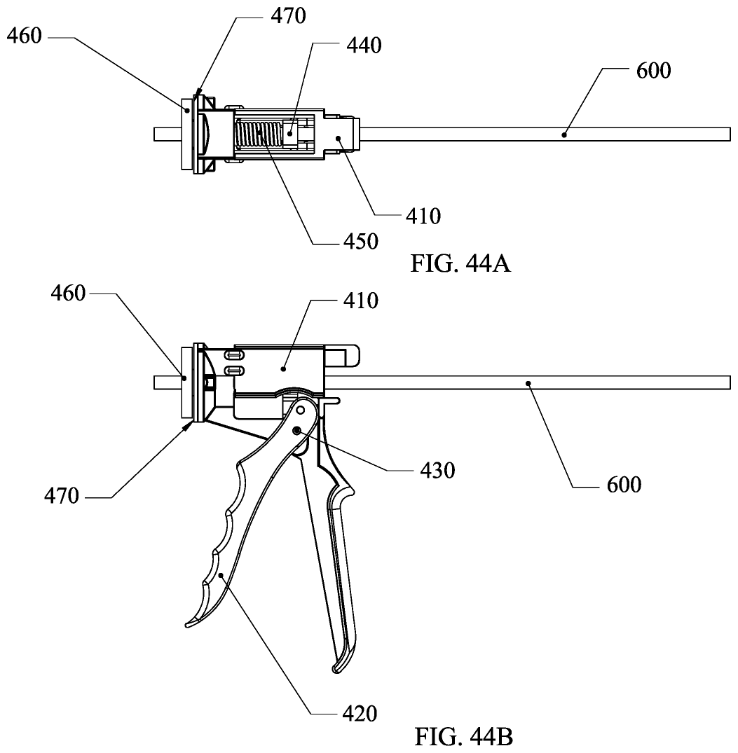

FIG. 44A is a top view illustration of a complete actuating device exemplary embodiment mounted upon a central rod. As shown, the central rod 600 passes through cavities in the frame 410, rod cam 440, compression spring 450, rubber washer 470, and spanner nut 460. FIG. 44B is a front view illustration of a complete actuating device exemplary embodiment mounted upon a central rod. As shown, the trigger 430 is connected to the frame 410 via trigger pins 430. The central rod passes through cavities in the frame 410, rubber washer 470, and spanner nut 460.

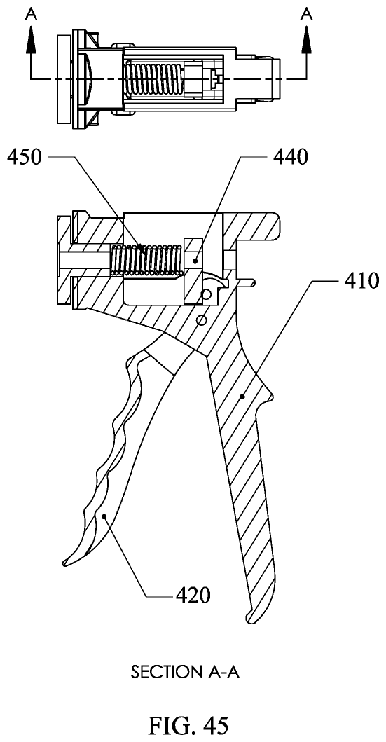

FIG. 45 is a full section view illustration of a complete actuating device exemplary embodiment. In the section view, the inner mechanics of the actuating device are shown. The rod cam 440 and compression spring 450 are located within the inner portion of the frame 410. The back face of the trigger 420 is also shown.

In some embodiments, the pusher rod 300 and cap have a travel limit so it would stop short of contacting the knife blade. In these or other embodiments, the cap is smaller than the diameter of the knife blade so that it can pass into the center blade area missing the cutting edges. In these or still other embodiments, the cap is be made out of synthetic resin or plastic. Any of these alternative embodiments impedes, reduces, or prevents the pusher cap from dulling the knife blades.

The corn stripping apparatus may further consist of a method for reversing the movement of the rod achieved by the initiation of the actuating device. Following the completion of the cutting of an ear of corn, the rod and corresponding pusher cap may be at the front of the holder apparatus and may be stopped by the blade and end cap from further movement. Prior to inserting the next ear of corn into the holder apparatus and beginning the cutting process, the rod and pusher cap must be returned to their initial positions, with the pusher cap at the base of the holder. This reversal may be achieved through a variety of manual or automated means.

In one embodiment, the reversal of the rod's movement may be achieved by the use of a thumb plate located directly behind the actuating device. Such a thumb plate may be directly coupled with the rod, applying pressure to keep the rod in place. When the plate is lifted, the pressure may be released and the rod may be pulled back to its initial position. In some embodiments, such a thumb plate may be directly coupled to an upper extrusion from the frame of the actuating device, described further above. The thumb plate may, in some embodiments, be directly behind a compression spring. Such a compression spring may aid in allowing for the thumb plate's pressure on the rod to be lifted.

Exemplary embodiments of the aforementioned compression spring may contain diameters or sizes approximately equivalent to or slightly larger than the diameter or size of the rod, such that it may securely fit onto the rod. In one embodiment, the compression spring may be constructed and formed of aluminum. In another embodiment, the compression spring may be constructed and formed of stainless steel. In yet other embodiments, the compression spring may be constructed and formed of any material such that the spring may successfully aid in removing pressure from the rod. In some embodiments, the compression spring may be directly coupled to the thumb plate to ensure a secure connection. In one of these such embodiments, for example, the compression spring may be attached to the thumb plate through use of glue or another adhesive. In another one of these such embodiments, the compression spring may be attached to the thumb plate via welding. In yet other embodiments, the compression spring may be attached to the thumb plate via any form of attachment such that the mechanisms of both components are not compromised. In other embodiments, there may not be any additional forms of attachment between the compression spring and the thumb plate, and mechanisms may rely on the proximity of the two components.

In some embodiments, the thumb plate may consist of at least three parts, including an upper part that may connect to the actuating device frame's upper protrusion, a middle part that may contain the central rod, and a lower part that may be pushed down during the reversal process. In one embodiment, the upper part of the thumb plate may be a U-shaped component. In another embodiment, the upper part of the thumb plate may be rectangular with a small cavity. In yet other embodiments, the upper part of the thumb plate may be of any geometry, with any size cavities or other features, such that it may fully fit into place with the frame's upper protrusion. The upper part of the thumb plate may be of any size fitting with the frame's upper protrusion, such that the thumb plate may be securely locked into place without excessive constraint or room for movement. In one embodiment, additional glue or adhesives may be used to secure this attachment and ensure the thumb plate is locked into place. In another embodiment, additional bolting or other forms of mechanical attachment may be used to secure this attachment and ensure the thumb plate is locked into place. In yet another embodiment, no additional attachment methods may be used, and the secure attachment may rely on proximity and geometry of the two components. In still other embodiments, any form of attachment may be used such that the thumb plate is securely locked into place.

The thumb plate may further contain a center portion wherein the apparatus' central rod is to be contained. In one embodiment, such a center portion may be of a flat, rectangular geometry. In another embodiment, such a center portion may be of a rounded geometry. In yet other embodiments, such a center portion may be of any geometry such that it may securely contain the rod. In many embodiments, the center portion may define a cavity for the rod to pass through. Such a cavity may be the primary form of attachment between the two components. In one embodiment, such a cavity may be circular. In another embodiment, such a cavity may be square. In yet another embodiment, such a cavity may be of any geometry such that it may securely hold the rod into place without excessive movement or constraint. It may be advantageous for the cavity to be of the same or similar geometry to the rod such that a secure connection is ensured. In many embodiments, the cavity may be of a diameter or size approximately equivalent to the diameter or size of the rod, which may allow for the rod to be secured by the thumb plate without excessive constraint or room for movement.

The thumb plate may further be consisted of a lower extruded portion to be pushed down by the user when engaging the reversal mechanism. In one embodiment, the lower extruded portion may be of a flat, rounded geometry. In another embodiment, the lower extruded portion may be of a rectangular geometry. In yet other embodiments, the lower extruded portion may be of any geometry such that the user may easily push the portion downwards to release pressure and bring the rod back. Once the lower extruded portion is pushed down and pressure is released, the user may physically bring the rod back to its initial position.

In one embodiment, the thumb plate may be constructed and formed of aluminum. In another embodiment, the thumb plate may be constructed and formed of stainless steel. In yet other embodiments, the thumb plate may be constructed and formed of any material such that material is strong enough to withhold user engagement and release pressure on the rod. In some embodiments of the corn stripping apparatus, a thumb plate may not be used, and another manual or automated mechanism may be included as a reversal mechanism.

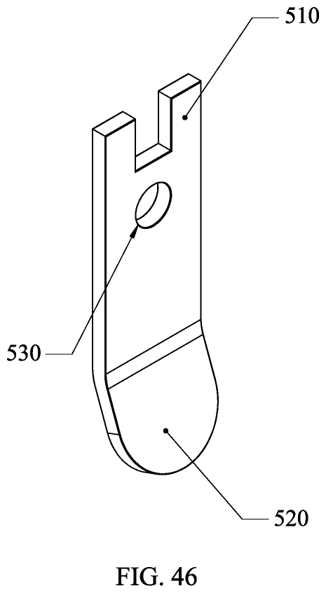

Turning now to FIG. 46, an isometric illustration of a thumb plate reversal mechanism exemplary embodiment is shown. As described, the thumb plate may consist of a number of different components, including an upper portion 510 to connect with the upper extrusion of the actuating device's frame. Such an upper portion 510 may be of any geometry such that it may securely connect to the upper extrusion. The thumb plate may further define a cavity 530 for the apparatus' central rod to pass through. Such a rod cavity 530 may be of a diameter approximately equivalent to the diameter of the central rod such that the rod may securely fit into the cavity without excessive constraint or room for movement. The thumb plate may finally consist of a lower portion 520 for user engagement. This lower portion 520 may be the portion physically pushed down by the user.

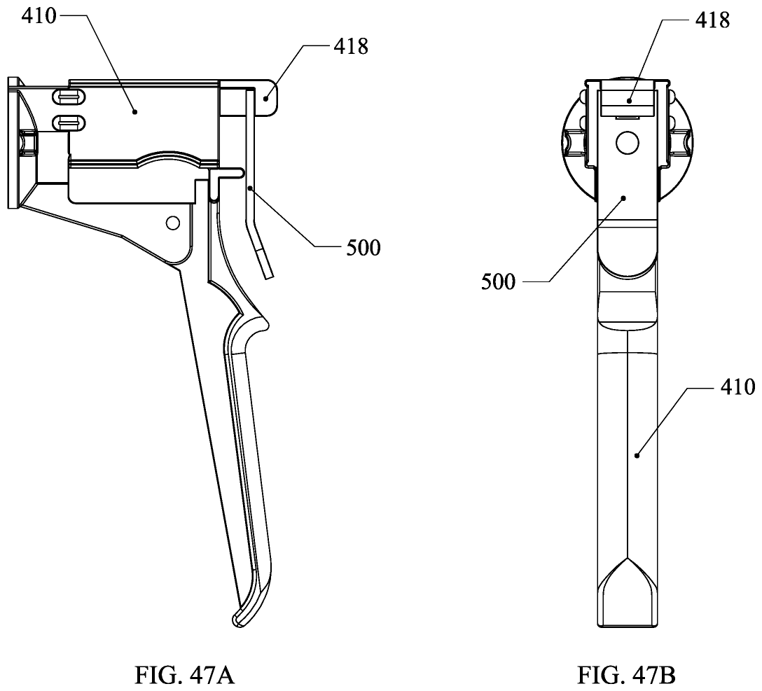

FIG. 47A is a front view illustration of a thumb plate exemplary embodiment coupled with an actuating device frame exemplary embodiment. The thumb plate 500 connects to the frame 410 via an upper extrusion 418 on the frame. Such an upper extrusion 418 may be of a geometry such that it may automatically connect with the thumb plate and lock the component into place. FIG. 47B is a side view illustration of a thumb plate exemplary embodiment coupled with an actuating device frame exemplary embodiment. As shown, the upper portion of the thumb plate 500 connects with the upper extrusion 418 on the frame 410. In some embodiments, additional attachment methods may be used to ensure secure coupling of the components.

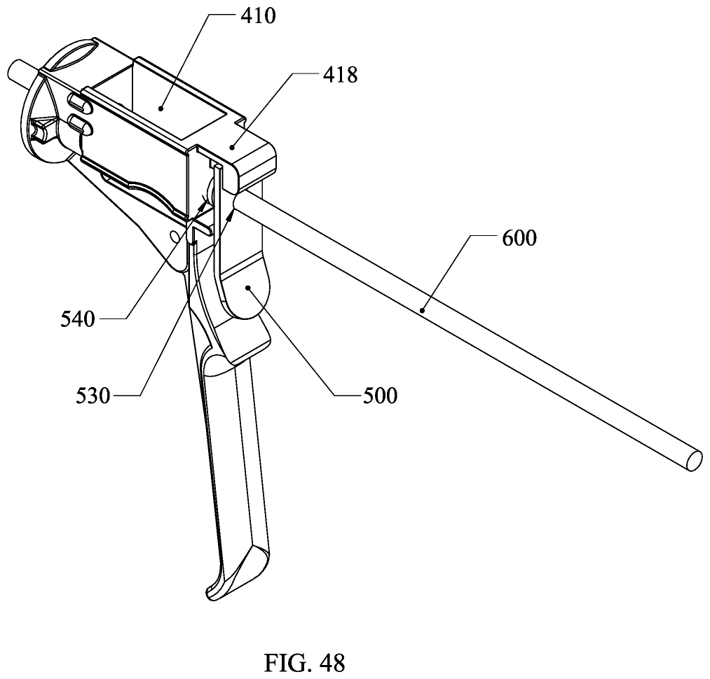

FIG. 48 is an isometric illustration of a thumb plate reversal mechanism exemplary embodiment coupled with an actuating device frame exemplary embodiment and mounted upon a central rod. As shown, the thumb plate 500 is coupled with the frame 410 via an upper extrusion 418. A compression spring 540 is located directly in front of the thumb plate 500 and may assist in the reversal process. The central rod 600 passes through a rod cavity 530 in the thumb plate and similar cavities in the frame, allowing the thumb plate to reverse the rod's movement.

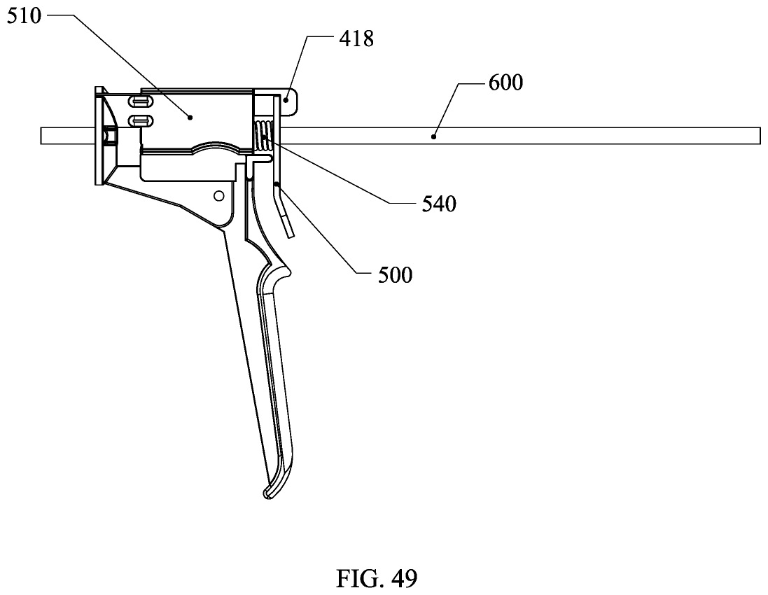

FIG. 49 is a front view illustration of a thumb plate reversal mechanism exemplary embodiment, coupled with the actuating device frame and central rod. As shown, the thumb plate 500 is coupled with the frame 410 via an upper extrusion 418. A compression spring 500 is located directly in front of the thumb plate. The central rod 600 passes through rod cavities in the thumb plate and frame, emerging on the opposite side of the frame.

However, as discussed above, the present disclosure is intended to cover many other alternatives. For example, some embodiments may include two or more pusher rods. In these and other embodiments, instead of statically attaching the blade to the distal end of the device, the blade can be attached to the pusher rods and thereby moves along with the pusher rod or rods to thereby contact and separate the corn kernels from the ear of corn.

What is claimed is:

1. An apparatus for separating corn kernels from a cob of an ear of corn, each of the corn kernels defining a base portion that is attached to an exterior of the corn cob, the apparatus comprising:
a circular blade defining an axis and a central aperture around the axis that is open at front and rear ends;
a holder that is configured to retain the ear of corn along the axis of the circular blade; and
a driver that is configured to move the ear of corn along the axis toward the blade, to enable the blade to contact the base of the corn kernels so as to separate the contacted corn kernels from the corn cob, and thereafter move the corn cob that has been separated from the corn kernels through the blade central aperture so as to exit the rear end, the driver being configured to receive manually input force and to increase power of the input force to result in increased force applied to the corn cob.

2. The apparatus of claim 1, wherein the driver includes a central rod, the central rod passing through the holder so as to push the ear of corn toward the blade.

3. The apparatus of claim 2, wherein the driver includes a trigger configured to actuate movement of the central rod.

4. The apparatus of claim 3, wherein the trigger includes frame and trigger components, the frame being stationary and the trigger being movable such that it may be manually pulled away from the blade to initiate movement of the central rod toward the blade.

5. The apparatus of claim 4, wherein the driver includes at least one trigger pin that couples the frame and trigger components.

6. The apparatus of claim 5, wherein the at least one trigger pin is independent of the frame component, the trigger pin being configured such that movement of the trigger initiates movement of the trigger pin.

7. The apparatus of claim 6, wherein the driver includes a rod cam component configured to directly contact the independent trigger pin such that movement of the trigger pin initiates movement of the rod cam component.

8. The apparatus of claim 7, wherein the rod cam component is securely coupled to the central rod such that movement of the rod cam component initiates movement of the central rod.

9. The apparatus of claim 8, wherein the driver includes a compression spring directly in front of the rod cam component, such that the movement of the rod cam component initiates compression of the compression spring, the compression spring decompressing and pushing the rod cam component back to its initial position while maintaining the position of the central rod following release of the trigger.

10. The apparatus of claim 2, wherein the driver includes a secondary pusher component coupled to the central rod, the secondary pusher component making direct contact with the base of the ear of corn such that the ear of corn is driven forward towards the blade.

11. The apparatus of claim 2, wherein the driver includes an electric motor components such that the rod is driven forward by the electric motor.

12. The apparatus of claim 1, wherein the holder includes a portion configured to hold the blade such that the blade is securely incorporated into the holder.

13. The apparatus of claim 12, wherein the blade is configured to be removable from the holder.

14. The apparatus of claim 1, wherein the holder is configured to be removable from The blade and driver.

15. The apparatus of claim 1, wherein the holder defines openings such that the holder contains the ear of corn and allows separated corn kernels to escape through the openings.

16. The apparatus of claim 1, wherein the holder includes an end cap to secure the blade, the end cap defining a cavity configured to allow the cob to pass therethrough following separation of the corn kernels.

17. The apparatus of claim 16, wherein the end cap surrounds an exterior of the rear end of the blade.

18. The apparatus of claim 2, wherein the drive includes a reversal mechanism for moving the central rod away from the blade.

19. The apparatus of claim 18, wherein the reversal mechanism includes thumb plate and compression spring components such that the components apply and release pressure upon the central rod to reverse the motion of the central rod.

20. The apparatus of claim 1, wherein the blade is configured to be tapered in geometry.
